(19) United States
(12) Patent Application Publication
(10) Pub. No.: US 2012/0054666 A1
(43) Pub. Date: Mar. 1, 2012

(54) NETWORKED SYSTEM WITH SUPPORTING MEDIA ACCESS AND SOCIAL NETWORKING

(76) Inventors: Anselm P. Baird-Smith, San Jose, CA (US); Payam Mirrashidi, San Francisco, CA (US); Steve S. Gedikian, Redwood City, CA (US)

(21) Appl. No.: 13/216,197

(22) Filed: Aug. 23, 2011

Related U.S. Application Data
(60) Provisional application No. 61/378,839, filed on Aug. 31, 2010.

(51) Int. Cl. G06F 15/16; G06F 3/048

(52) U.S. Cl. 715/780; 709/204

(57) ABSTRACT

Embodiments for a networked system that supports access to media assets as well as social interactions amongst users are disclosed. One aspect can pertain to a networked system and method for providing recommendations to users of the networked system. The networked system can provide media content and/or a social network to users. For example, the networked system can pertain to a media system incorporating social networking. The networked system can evaluate users and/or activities to determine when and to which users a recommendation should be provided. Another aspect can pertain to creation or editing of profiles. The profiles can be used with an online media system. A profile for a user can include information about users, including a media profile that represents the media interests of the user. The profiles can also facilitate social networking via the online media system.

### CROSS-REFERENCE TO RELATED APPLICATION

This application claims priority to U.S. Provisional Patent Application No. 61/378,839, filed Aug. 31, 2010, entitled “NETWORKED SYSTEM FOR SUPPORTING MEDIA ACCESS AND SOCIAL NETWORKING,” and incorporated herein by reference for all purposes.

### BACKGROUND OF THE INVENTION

In recent times, social networks have become popular. Social networks allow social interaction online amongst users located anywhere in the world. Typically, in a social networking system, users have a user page that can be accessible to other users. Furthermore, in some social networking systems, one user can “follow” another user. Typically, when one or more users follow another user, “posts” provided by the followed user can be presented to all the followers of the followed user. The “posts” can be presented as a status update, a location, a mood/feeling, or a thought provided by the user. In some systems, location status can be updated automatically. However, there is a continuing need to enhance social networks to better support and serve its users.

Thus, there is a need for improved techniques to facilitate and manage providing information to followers in a social networking environment.

### SUMMARY

Embodiments of the invention pertain to a networked system that supports access to media assets as well as social interactions amongst users.

One aspect disclosed herein pertains to a networked system and method for providing recommendations to users of the networked system. The networked system can provide media content and/or a social network to users. For example, the networked system can pertain to a media system incorporating social networking. The networked system can evaluate users and/or activities to determine when and to which users a recommendation should be provided. Even if a recommendation is provided to more than one user, the recommendation can be different for different users (or groups of users).

Another aspect disclosed herein pertains to creation or editing of profiles. As noted above, profiles can be used with an online media system. A profile for a user can include information about users, including a media profile that represents the media interests of the user. The profiles can also facilitate social networking via the online media system. The profiles can be manually or automatically created.

Various embodiments, implementations and aspects are described below. The invention can be implemented in numerous ways, including as a method, system, device, apparatus (including computer readable medium and graphical user interface). Several embodiments of the invention are discussed below.

As a method for providing a recommendation to a user of a social networking system, one embodiment can, for example, include at least: receiving one or more events concerning activity at the social networking system; determining whether to trigger a recommendation based on the one or more of the received events; identifying one or more users of the social networking system that are potentially interested candidates; preparing at least one content recommendation; and rendering the at least one content recommendation available for presentation to one or more of the respective users.

As a non-transitory computer readable medium including at least computer program code stored for providing a recommendation to a user of a networked system, one embodiment can, for example, include at least: computer program code for receiving one or more events concerning activity at the social networking system; computer program code for determining whether to trigger a recommendation based on the one or more of the received events; computer program code for identifying one or more users of the social networking system that are potentially interested candidates; computer program code for preparing at least one content recommendation; and computer program code for rendering the at least one content recommendation available for presentation to one or more of the respective users.

As a method for forming a profile for a user of a social networking system, one embodiment can, for example, include at least: maintaining user data for each of a plurality of users of the social networking system; identifying a particular user for which a media profile is to be created or edited; accessing user data for the particular user that is maintained by the social networking system; automatically selecting at least one media item for inclusion into the media profile based on the user data, the at least one media item being selected from a plurality of media items; and including the selected at least one media item in the media profile.

As a computer readable medium including at least computer program code for forming a profile for a user of an online media system, one embodiment can, for example, include at least: computer program code for maintaining user data for each of a plurality of users of the social networking system; computer program code for identifying a particular user for which a media profile is to be created or edited; computer program code for accessing user data for the particular user that is maintained by the social networking system; computer program code for automatically selecting at least one media item for inclusion into the media profile based on the user data, the at least one media item being selected from a plurality of media items; and computer program code for including the selected at least one media item in the media profile.

As a graphical user interface for providing a user profile, one embodiment can, for example, include at least: a personal information region configured to facilitate user entry of information pertaining to a user; and a media interests region configured to facilitate identification media items of interest to the user.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a social activity following system according to one embodiment.

FIG. 2 is an illustrative diagram of a user page according to one embodiment.

FIG. 3A is a user page according to one embodiment.

FIG. 3B is a user page according to another embodiment.

FIG. 4 is a connection page according to one embodiment.

FIG. 5A is a block diagram of an event processing system according to one embodiment.

FIG. 5B is a block diagram of an event processing system according to another embodiment.

FIGS. 6A and 6B are flow diagrams of a commerce posting process according to one embodiment.

FIG. 7 is a flow diagram of a followed activity posting process according to one embodiment.

FIG. 8 is a block diagram of a networked system according to one embodiment.

FIG. 9 is a block diagram of a recommendation system according to one embodiment.

FIG. 10 illustrates a flow diagram of a media recommendation process according to one embodiment.

FIG. 11 illustrates an exemplary welcome page according to one embodiment.

FIG. 12 illustrates an exemplary welcome page according to one embodiment.

FIG. 13 illustrates an exemplary artist recommendation page according to one embodiment.

FIG. 14 is a flow diagram of a profile setting process according to one embodiment.

FIG. 15 is a view of a general profile page according to one embodiment.

FIG. 16A is a view of a representative profile creation screen according to one embodiment.

FIG. 16B is a view of another profile creation screen according to one embodiment.

FIG. 16C is another view of the profile creation screen illustrated in FIG. 16B according to one embodiment.

FIG. 16D is another view of the profile creation screen illustrated in FIG. 16B according to one embodiment.

FIG. 16E is a view of another profile creation screen according to one embodiment.

FIG. 17 is a view of a representative profile edit screen according to one embodiment.

FIG. 18 is a view of a representative artist profile edit screen according to one embodiment.

FIG. 19 is a flow diagram of a media profile setting process according to one embodiment.

FIG. 20 illustrates a block diagram of a computing device according to one embodiment.

### DETAILED DESCRIPTION OF EMBODIMENTS OF THE INVENTION

Embodiments of the invention pertain to networked system that supports access to media assets as well as social interactions amongst users. Various embodiments, implementations and aspects are described below.

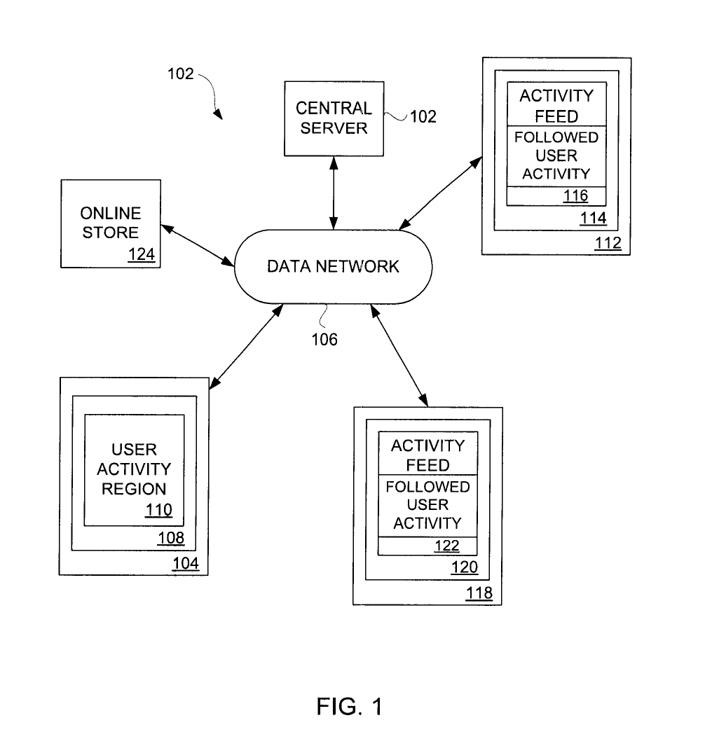

Several embodiments of the invention are discussed below with reference to FIGS. 1-20. However, those skilled in the art will readily appreciate that the detailed description given herein with respect to these figures is for explanatory purposes as the invention can extend beyond these limited embodiments.

According to one aspect, enhanced online social networks are disclosed herein. According to one embodiment, methods and systems being described can facilitate and manage “posts” amongst followers. The posts can be user-initiated or system-initiated. For example, a system-initiated post can occur when a follower performs a commerce event. The enhanced online social network can be integrated or coupled with an electronic commerce site (e.g., online store). As such, purchases at the electronic commerce site can be used to inject commerce related posts to followers' feeds. Additionally, for a given user, posts to a user's feed can be managed to limit or filter posts so that those posts being posted are more likely to be of interest to the given user.

FIG. 1 is a block diagram of a social activity following system 100 according to one embodiment. The social activity following system 100 includes a central server 102. The central server 102 includes one or more processing units to perform computer program code stored on one or more data storage devices. The central server 102 can also store profile and other information pertaining to a plurality of users. Users of the social activity following system 100 can follow access their profile as well as profiles other users. Additionally, users of the social activity following system 100 can allow users to follow other users. Still further, the social activity following system 100 can provide recommendations of other users that one might be interested in following.

The social activity following system 100 also supports a plurality of user computers that can be associated with users. In particular, the social activity following system 100 illustrates a user computer 104 that can couple to a data network 106. The central server 102 is also coupled to the data network 106. The user computer 104, though interaction with the central server 102, is capable of presenting a user page 108. For example, the user computer 104 can include a display that is capable of presenting the user page 108. According to one embodiment, the user page 108 can include a user activity region 110. The user activity region 110 can present an activity feed within the user activity region 110.

The social activity following system 100 can also support a plurality of follower computers that can be associated with users that follow other users. In the example illustrated in FIG. 1, there are two followers of the user associated with the user computer 104. Specifically, the social activity following system 100 can support a follower computer 112 having a display capable of presenting a follower page 114. The follower page 114 can include an activity feed 116. The activity feed 116 can, among other things, include followed user activity. As an example, the followed user activity being presented in the activity feed 116 can pertain to the user activity associated with at least the user of the user computer 104. However, typically, the followed user activity being presented in the activity feed 116 can pertain to the user activity associated with the user of the user computer 104 as well as user activity associated with various other users also being followed. Additionally, the social activity following system 100 can support a follower computer 118 having a display capable of presenting a follower page 120. The follower page 120 can include an activity feed 122. The activity feed 122 can, among other things, include followed user activity. As an example, the followed user activity being presented in the activity feed 122 can pertain to at least the user activity associated with the user of the user computer 104. In another example, the followed user activity being presented in the activity feed 122 can pertain to the user activity associated with the user of the user computer 118 as well as user activity associated with various other users also being followed.

More generally, the user page 108 as well as the follower pages 114, 120 are electronic pages. The user computer 104 receives the electronic page for the user page 108 from the central server 102, and then presents the electronic page on the display of the user computer 104. The follower computers 112, 118 respectively receive electronic pages for the follower pages 114, 120, and then respectively present the electronic pages on the displays of the follower computers 112, 118.

The central server 102 can manage the activity feeds for the various users, including followers. That is, when the user activity feed within user activity region 110 is updated (e.g., by including a new activity posting), the updated user activity can also propagate to the followers of the user. In such case, the corresponding follower pages 114, 120 can be updated to include followed user activity corresponding to the updated user activity within the activity feeds 112, 122. However, it should be noted that a follower typically follows a plurality of different users. As such, the activity feeds presented on a follower page typically integrate activity from a plurality of different users as well as activity associated with the corresponding follower (user).

The social activity following system 100 can also support an online store 124. The user can interact with the online store 124 to engage in e-commerce transactions to purchase products or services. In one embodiment, the online store 124 can facilitate purchase of electronic products (or digital assets), such as digital media or software programs. As one example, the online store 124 can pertain to an online media store from which users can purchase numerous media items. As another example, the online store 124 can pertain to an online application store from which users can purchase numerous application programs. As discussed in detail below, if a purchase occurs from the online store 124 by the user, an activity event can be produced. The activity event can be inserted into the user activity region 110 of the user page 108. The central server 102 can also propagate or provide the activity event of the user to those of the followers of the user. Consequently, the follower pages 114, 120 of the follower pages 112, 118 can receive the activity event associated with the user and cause an activity post to be presented in the activity feed associated with the follower pages 114, 120.

Although the central server 102 and the online store 124 are depicted in FIG. 1 as being separate devices, it should be understood that the central server 102 and the online store 124 can both be hosted on the same device (e.g., server).

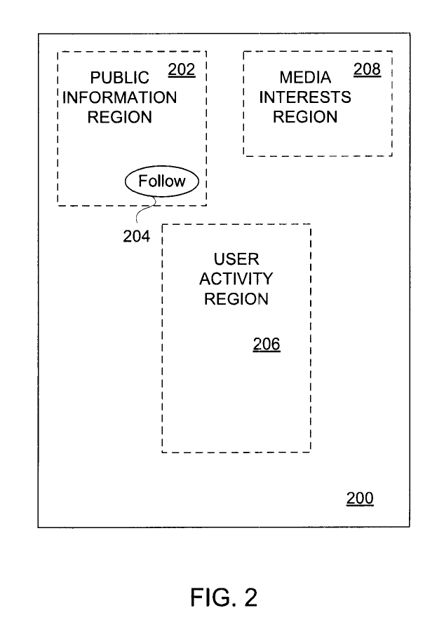

FIG. 2 is an illustrative diagram of a user page 200 according to one embodiment. The user page 200 can, for example, represent one implementation of the user page 108 illustrated in FIG. 1.

The user page 200 can include a public information region 202 that can include information descriptive of the user. The public information region 202 can be publicly accessible by any user. The user page 200 can also include a user control 204 to request to follow the user associated with the user page 200. Additionally, the user page 200 can include a user activity region 206. The user activity region 206 can be controlled such that it is visible to only authorized users. For example, the user activity region 206 would be visible to (i) the user associated with the user page 200, and (ii) followers of the user (which have implicitly or explicitly been authorized to view the user activity region 206). Still further, the user page 200 and can include a media interest region 208. The media interest region 208 can identify one or more media assets or characterize media interests to thereby provide information to other users regarding the media interests of the user corresponding to the user page 200. The media interests can pertain to one or more different types of media assets, including songs, collection of songs (e.g., albums), movies, images, podcasts, electronic books, games or applications. More generally, media assets can be denoted as digital assets, though since most digital assets which have a media aspect, the digital assets are also typically media assets.

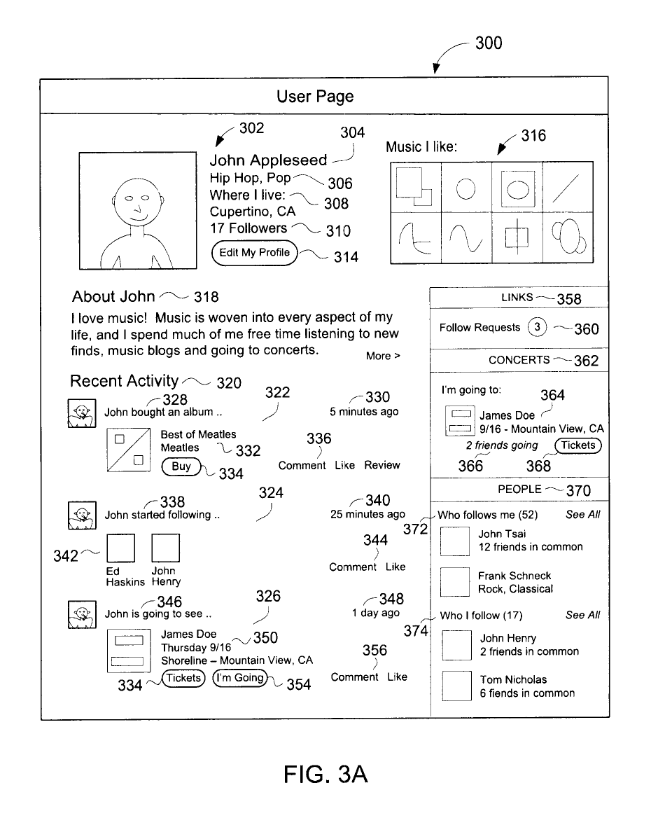

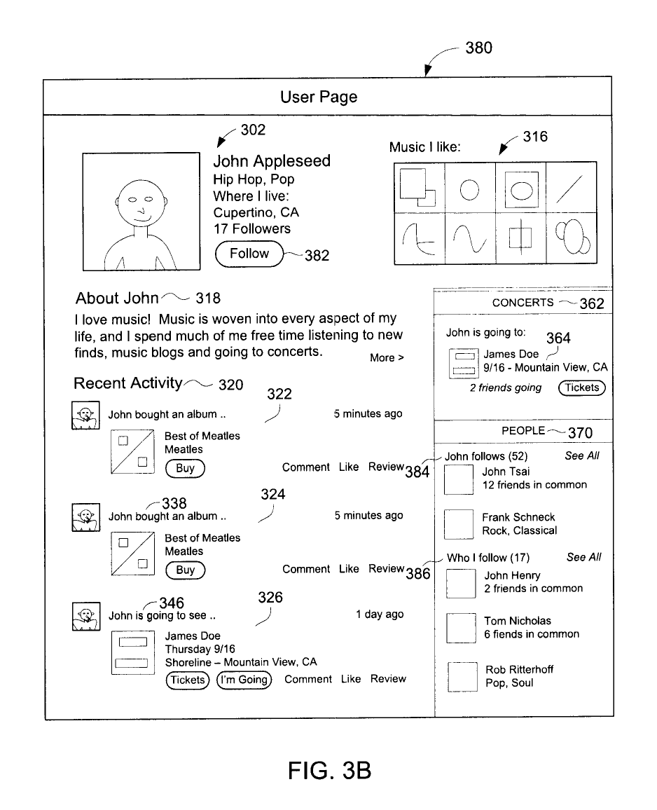

FIG. 3A is a user page 300 according to one embodiment. The user page 300 pertains to a particular user of the users of a social network system, such as the social activity following system 100. The user page 300 can represent a user page for a user when being viewed by that user. The user page 300 can represent a user page of the social activity following system 100 illustrated in FIG. 1. For example, in one implementation, the user page 300 can be an electronic page that is provided by the central server 102 to the user computer 104 for display.

The user page 300 can be presented to the particular user. In this embodiment, the user page 300 is the user page for the particular user. The user page 300 includes a user section 302 that provides basic description (i.e., profile) for the user. As illustrated in FIG. 3A, the user section 302 can include a name 304, music genres of interest 306, where the user lives 308, number of followers 310, and an associated image 312. In addition, the user section 302 can include a user control 314 that allows the user to edit the user's profile.

The user page 300 can also include an “I like” section 316. Here, the user can depict digital assets, namely, digital media assets, that they like. For example, as illustrated in FIG. 3A, the digital media assets can pertain to music and representations of selected albums can be represented. In the specific example illustrated in FIG. 3A, the “I like” section 316, there is a grid-like presentation of eight albums that represents the musical tastes (i.e., likes) of the user. The selection of the albums to be represented can be manually performed by the user or automatically performed by the system.

The user page 300 can also include an about section 318. In this example, the about section 318 is denoted “About John” since the particular user is named John. The about section 318 can include a description of the particular user. If an extensive description is provided, an initial portion of the description can be displayed with any remaining portion being accessible via “more” user control provided in or adjacent to the about section 318.

The user page 300 can also include a “recent activity” section 320. The recent activity section 320 can include recent activity associated with, in this case, the particular user. In the user page 300 shown in FIG. 3A, the recent activity section 320 includes three (3) distinct recent activities of the particular user. These distinct recent activities can be referred to as a first recent activity 322, a second recent activity 324, and a third recent activity 326.

The first recent activity 322 has an activity type description 320 that indicates that the particular user, i.e., John, recently bought an album. A timing indication 330 indicates that the album was, in this example, purchased five (5) minutes ago. The first recent activity 322 can also provide descriptive information 332 for the album that has been purchased. In this example, the descriptive information 332 can include the title of the album, the name of the artist, and a representative image (such as album cover art). Still further, the first recent activity 332 can include a user control 334 that facilitates purchase of the same album that was previously bought. The first recent activity 322 can also display user controls 336 that allow users to leave a comment, indicate that they like (or dislike) the purchase, or provide a review for the album.

The second recent activity 324 has an activity type description 338 that indicates that the particular user, i.e., John, recently started to follow one or more other users (e.g., people or artists). A timing indication 340 indicates that, in this example, the particular user starting follow the one or more other users twenty-five (25) minutes ago. The second recent activity 324 can also provide followed user information 342 to identify the one or more other users being now followed by the particular user. For example, the followed user information 342 can provide a name and an associated image for each of the newly followed users. The second user activity 324 can also display user controls 344 that allow users to leave a comment or indicate that they like (or dislike) the following of the newly followed users.

The third recent activity 326 has an activity type description 346 that indicates that the particular user, i.e., John, is going to see an event. In this example, the event is a concert but in general that event can be any event (though preferably a ticketed event). A timing indication 348 indicates that the particular user decided to go (or confirm he was going) to the event one (1) day ago. The third recent activity 326 can also provide descriptive information 350 for the concert. In this example, the descriptive information 350 can include the name of the artist, date and location for the concert and can also include a representative image (such as concert poster). Still further, the third recent activity 326 can include a user control 352 that facilitates purchase of tickets to the concert, and/or a user control 354 that enables a user to designate that they are going to the concert. The third user activity 326 can also display user controls 356 that allow users to leave a comment or indicate that they like (or dislike) the concert.

The user page 300 can also include a links section 358. In the links section 358 information concerning links or connections for the particular user of the user page 300 can be provided. As illustrated in FIG. 3A, the links section 358 can indicate to the particular user the number of outstanding follow requests 360 that have been received. In this example, the links section 358 indicates that the particular user has three (3) pending follow requests.

The user page 300 can also include a concert section 362. In the concert section 362, information concerning one or more concerts can be provided. The concerts are, however, concerts that the particular user has previously indicated that they are going. As illustrated in FIG. 3A, the concert section 362 indicates that the particular user is going to a particular concert. Concert information 364 can be provided in the concert section 362 to describe the particular concert. For example, the concert information 364 can include name of the artist, the date of the concert, the location of the concert, and perhaps a graphic associated with the artist or concert. In addition, the concert section 362 can provide a friends indication 366 that identifies those friends of the particular user that the system knows that are going to the same concert. In this example, the friends indication 366 denotes that “2 friends going”. Still further, the concert section 362 can provide a user control 368 that facilitates purchase of tickets to the particular concert.

The user page 300 can also include a people section 370. The people section 370 can provide abbreviated listings for people of the user follows or is followed by. The people section 370 can include a “who I follow” section 372 that can depict information on a subset of the other users that the particular user of the user page 300 follows. The people section 370 can also include a “who follows me” section 374 that can depict information on a subset of those other users that are currently following the particular user of the user page 300. The people section 370 can also include user controls (e.g., “See All”) that allow the user to see all of the people that the user follows or that follow the user.

FIG. 3B is a user page 380 according to another embodiment. The user page 380 pertains to a particular user of the users of a social network system, such as the social activity following system 100. The user page 380 can represent a connection page of the social activity following system 100 illustrated in FIG. 1. The user page 380 can represent a user page for a particular user when being viewed by another user that is not presently following the particular user.

The user page 380 can be presented to the another user. In this embodiment, the user page 380 is the user page for a particular user that the another user is interested in viewing (and possibly following). The user page 380 is generally similar to the user page 300 illustrated in FIG. 3A. There are, however, some differences. The user section 302 is generally the same; however, the user control 314 can be replaced with a user control 382 (e.g., “Follow” button). The user control 382 facilitates the another user in requesting to follow the particular user. The “I like” section 316, the about section 318, the “recent activity” section 320, and the concerts section 362 can all be same or similar to that described with reference to FIG. 3A. The links section 358 is removed from the user page 380 since such is inappropriate for the another user. The people section 370 is generally similar to that described with reference to FIG. 3A. However, one sub-sections in the people section 370 can be recast as “John follows” and can depict information on a subset of the other users that the particular user (i.e., John) of the user page 300 follows. The other sub-section in the people section 370 can be recast as “Who follows me” and can depict information on a subset of those other users that are currently following the particular user of the user page 300.

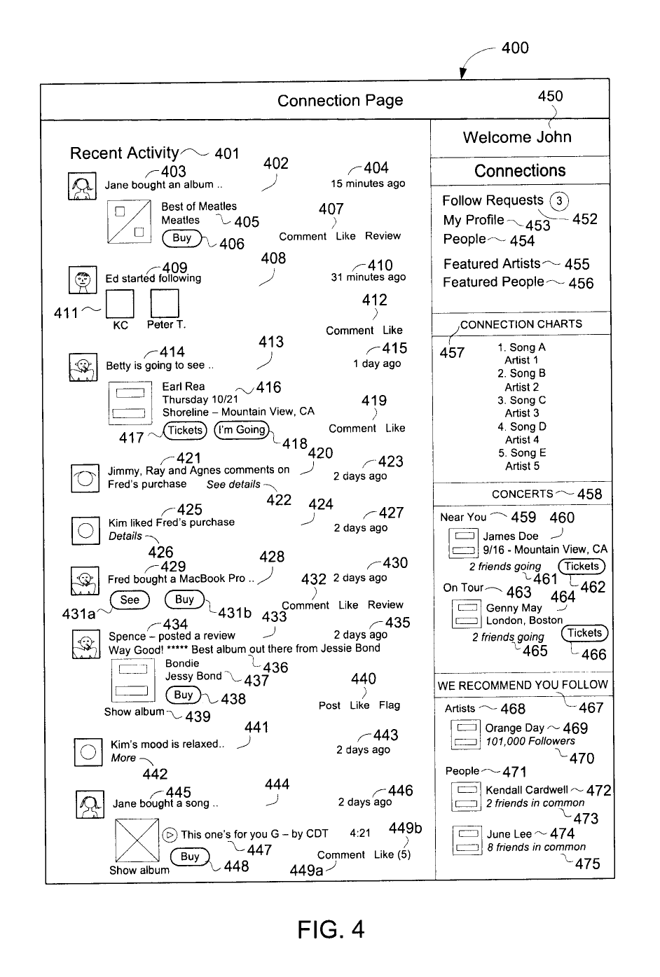

FIG. 4 is a connection page 400 according to one embodiment. The connection page 400 pertains to a particular user of the users of a social network system, such as the social activity following system 100. The connection page 400 can represent a page providing activity information concerning various other users that the particular user follows. The connection page 400 can represent a page provided by the social activity following system 100 illustrated in FIG. 1. For example, in one implementation, the connection page 300 can be an electronic page that is provided by the central server 102 to the user computer 104 for display. Also, since the connection page 400 is affiliated with a user, the connection page 400 can also be referred to as a user page.

The connection page 400 can be presented to the particular user. In this embodiment, the connection page 400 is a connection for the particular user. The connection page 400 provides information, such as activity information, concerning connections (e.g., other users that are followed) to the particular user.

The connection page 400 can include a “recent activity” section 401. The recent activity section 401 can pertain to an activity feed being presented by the connection page 400. The recent activity section 401 can include recent activity associated with those other users being followed by the particular user. In the connection page 400 shown in FIG. 4, the recent activity section 401 includes a plurality of distinct recent activities of various other users. These distinct recent activities can be presented in a list format with most recent activities at the top of the list. In one embodiment, more recent activities (e.g., activity events) of those users being followed can be noted towards the top portion of the recent activity section 401.

A first recent activity 402 has an activity type description 403 that indicates that a user, i.e., Jane, recently bought an album. A timing indication 404 indicates that the album was, in this example, was purchased fifteen (15) minutes ago. The first recent activity 402 can also provide descriptive information 405 for at the album that has been purchased. In this example, the descriptive information 405 can include the title of the album, the name of the artist, and a representative image (such as album cover art). Still further, the first recent activity 402 can include a user control 406 (e.g., “Buy” button) that facilitates purchase of the same album that was previously bought. The first recent activity 402 can also display user controls 407 that allow users to leave a comment, indicate that they like (or dislike) the purchase, or provide a review for the album.

A second recent activity 408 has an activity type description 409 that indicates that a user, i.e., Ed, recently started to follow one or more other users (i.e., KC and Peter T.). A timing indication 410 indicates that, in this example, the user starting follow these one or more other users thirty-one (31) minutes ago. The second recent activity 408 can also provide followed user information 411 to identify the one or more other users being now followed by the user (i.e., Ed). For example, the followed user information 411 can provide a name and an associated image for each of the newly followed users. The second user activity 408 can also display user controls 412 that allow users to leave a comment or indicate that they like (or dislike) the following.

A third recent activity 413 has an activity type description 414 that indicates that a user, i.e., Betty, is going to see an event. In this example, the event is a concert but in general that event can be any event (though preferably a ticketed event). A timing indication 415 indicates that the particular user decided to go (or confirm she was going) to the event one (1) day ago. The third recent activity 413 can also provide descriptive information 416 for the concert. In this example, the descriptive information 416 can include the name of the artist, date and location for the concert and can also include a representative image (such as concert poster). Still further, the third recent activity 413 can include a user control 417 (e.g., “Tickets” button) that facilitates purchase of tickets to the concert, and/or a user control 418 (e.g., “I'm Going” button) that enables a user to designate that they are going to the concert. The third user activity 413 can also display user controls 419 that allow users to leave a comment or indicate that they like (or dislike) the concert.

A fourth recent activity 420 has an activity type description 421 that indicates that users, i.e., Jimmy, Ray and Agnes, have recently commented on a posted purchase by another user (i.e., Fred). A “See details” user control 422 (e.g., link) allows access to the specific comments by Jimmy, Ray and Agnes. A timing indication 423 indicates that, in this example, the users commented two (2) days ago.

A fifth recent activity 424 has an activity type description 425 that indicates that a user, i.e., Kim, “liked” the purchase made by another user (i.e., Fred). A “Details” user control 426 (e.g., link) allows access to details of the post by Kim, if any. A timing indication 427 indicates that, in this example, the user commented two (2) days ago.

A sixth recent activity 428 has an activity type description 429 that indicates that a user, i.e., Fred, recently bought a product. In this example, the product is a MacBook Pro™, which is a laptop computer from Apple Inc. A timing indication 430 indicates that the product was, in this example, purchased two (2) days ago. Although not shown in FIG. 4, the sixth recent activity 428 could also provide descriptive information (e.g., text and/or image) for at the product that has been purchased. The sixth recent activity 428 can include a user control 431a (e.g., “See” button) that facilitates seeing the product that was previously bought (e.g., by accessing an image, slideshow or movie), and/or a user control 431b (e.g., “Buy” button) that facilitates purchase of the same product that was previously bought. The sixth recent activity 428 can also display user controls 432 that allow users to leave a comment, indicate that they like (or dislike) the purchase, or provide a review for the product.

A seventh recent activity 433 has an activity type description 434 that indicates that a user, i.e., Spence, posted a review on a product or event. In this example, the review pertains to an album. A timing indication 435 indicates that the review was posted two (2) days ago. The seventh recent activity 433 can include review content 436 that contains at least a portion of the review. If more review content is available beyond that displayed a “More” link (not shown) can be provided to access the additional review content. The seventh recent activity 433 can also include descriptive information 437 for the product or event. In this example, the descriptive information 437 can include the name of the album, the artist, and can also include a representative image (such as album cover art). Still further, the seventh recent activity 433 can include a user control 438 (e.g., “Buy” button) that facilitates purchase of the product, e.g., album, that has been reviewed. The seventh recent activity 433 can also include a user control 439 (e.g., “Show album” link) that enable the user to view additional information concerning the album (e.g., track list, etc.). The seventh recent activity 433 can also display user controls 440 that allow users to post the review, indicate that they like (or dislike) the review, or flag the review for editorial review.

A eighth recent activity 441 has an activity type description 442 that indicates that a user, i.e., Kim, has indicated her mood as “relaxed”. A “More” user control (e.g., link) allows access to access additional details of the mood of Kim, if any. A timing indication 443 indicates that, in this example, the user posted her mood two (2) days ago.

A ninth recent activity 444 has an activity type description 445 that indicates that a user, i.e., Jane, recently bought a song. A timing indication 446 indicates that the album was, in this example, was purchased two (2) days ago. The ninth recent activity 444 can also provide descriptive information 447 for at the song that has been purchased. In this example, the descriptive information 405 can include the name of the song, the name of the artist, and a representative image (such as album cover art). Still further, the ninth recent activity 444 can include a user control 448 (e.g., “Buy” button) that facilitates purchase of the same song that was previously bought. A further user control can also be provided to allow a user to initiate preview of the song. The ninth recent activity 444 can also display user controls 449a that allow users to leave a comment, or indicate that they like (or dislike) the purchase. In this example, adjacent the user controls 449a is an indication 449b that five (5) others have already indicated that they like the purchase.

The connection page 400 can also include a greeting 450 for the user, which in this example is “John”. The connection page 400 can also include a connection navigation section 451. In the connection navigation section 451, the user can navigate to other pages, such as via a Follow Requests page indicator 452, a My Profile page indicator 453, a People page indicator 454, a Featured Artists page indicator 455, and a Featured People page indicator 456. These indicators can, for example, be links. As illustrated in FIG. 4, adjacent the Follow Requests page indicator, the connections navigation section 451 can indicate to the user the number of outstanding follow requests that have been received. In this example, the connection navigation section 451 indicates that the particular user has three (3) follow requests.

The connection page 400 can also include a connection charts section 457. The connection charts section 457 can include at least one chart of songs. For example, the chart can be a list of songs that are most popular, most frequently played, or most common amongst one's social network, etc. The connection charts section 457 shows a chart including five (5) songs.

The connection page 400 can also include a concert section 458. In the concert section 458, information concerning one or more concerts can be provided. The concerts are those that may be of interest to the user. The concerts section 458 includes a “Near You” section 459 where concerts near the user can be identified. As illustrated in FIG. 4, the Near You section 459 indicates that there is an upcoming concert in the geographic area of the user. Concert information 460 can be provided in the Near You section 459 to describe the particular concert. For example, the concert information 460 can include name of the artist, the date of the concert, the location of the concert, and perhaps a graphic associated with the artist or concert. In addition, the Near You section 459 can provide a friends indication 461 that identifies those friends of the particular user that the system knows are going to the same concert. In this example, the friends indication 461 denotes that “2 friends going”. Still further, the Near You section 459 can provide a user control 462 (e.g., “Tickets” button) that facilitates purchase of tickets to the particular concert.

The concerts section 458 can also include an “On Tour” section 463 where concerts our tour that may be of interest to the particular user. The one or more concerts identified in the On Tour section 463 can be determines by a server, such as the central server 102 illustrated in FIG. 1. The one or more concerts identified can be selected based on user interest (media profile, collection or usage), friends/followed users attending or liking, geographical, etc. As illustrated in FIG. 4, the On Tour section 463 indicates that there is an upcoming concert of likely interest to the user. Concert information 464 can be provided in the On Tour section 463 to describe the particular concert. For example, the concert information 464 can include name of the artist, the date of the concert, the location of the concert, and perhaps a graphic associated with the artist or concert. In addition, the On Tour section 463 can provide a friends indication 465 that identifies those friends of the particular user that the system knows are going to the same concert. In this example, the friends indication 465 denotes that “2 friends going”. Still further, the On Tour section 463 can provide a user control 466 (e.g., “Tickets” button) that facilitates purchase of tickets to the particular concert.

The connection page 400 can also include a “Recommend You Follow” section 467. The Recommend You Follow section 467 can identify those one or more other users that the system recommends the user, i.e., John, might want to follow. Specifically, the system recognizes categories of users, including artists and people. The Recommend You Follow section 467 can include an artist subsection 468 where one or more artists that are recommended can be identified. For a given artist being recommended, the artist subsection 468 can provide descriptive information 469 for the recommended artist. In this example, the descriptive information 469 can include the name of the artist and a representative image for the artist. The system can enable an artist to have a user page, or profile, that specifies the name and representative image for the artist. The artist subsection 468 can also provide a followers indication 470 that indicates a number of user presently following the recommended artist.

The Recommend You Follow section 467 can also include a people subsection 471 where one or more people that are recommended can be identified. For a first given person being recommended, the people subsection 471 can provide descriptive information 472 for the recommended person. In this example, the descriptive information 472 can include the name of the person and a representative image for the person. The system can enable a person to have a user page, or profile, that specifies the name, media likes, “about” information, and/or representative image for the person. The people subsection 471 can also provide a “friends in common” indication 473 that indicates a number of friends that the user, i.e., John, has in common with the recommended person. Similarly, for a second given person being recommended, the people subsection 471 can provide descriptive information 474 for the recommended person. In this example, the descriptive information 474 can include the name of the person and a representative image for the person. The people subsection 471 can also provide a “friends in common” indication 475 that indicates a number of friends that the user, i.e., John, has in common with the recommended person.

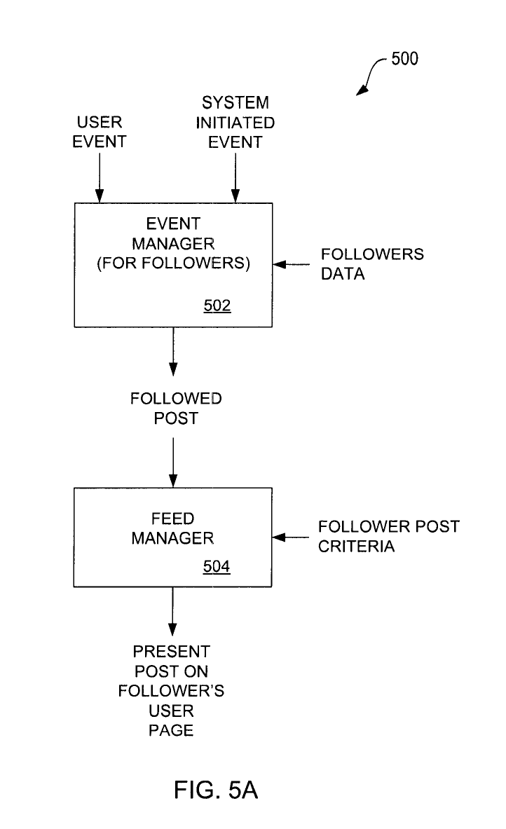

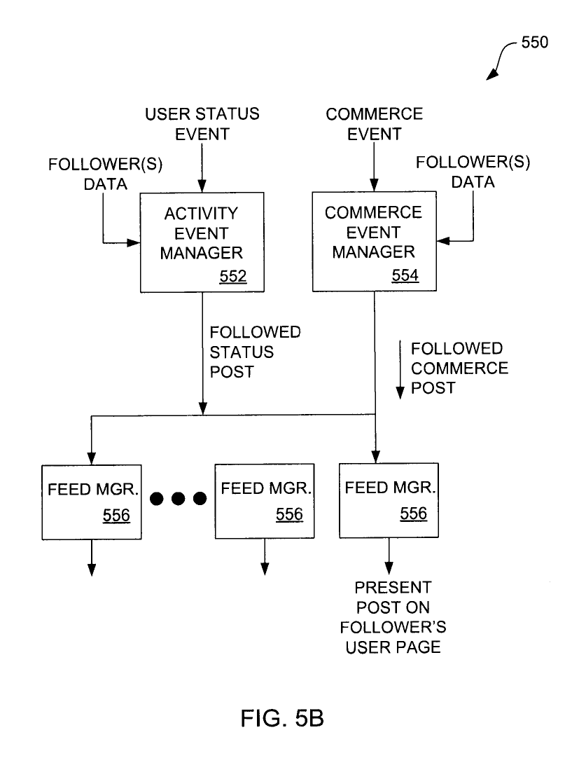

FIG. 5A is a block diagram of an event processing system 500 according to one embodiment. The event processing system 500 can include an event manager 502. The event manager 502 receives incoming events associated with a particular user. The event manager 502 can produce a followed post that can be supplied to one or more data followers. The one more data followers are users of the system that have elected to follow the particular user. The incoming events being received at the event manager 502 can include user initiated events and/or system initiated events. For example, a user initiated and is an event that is initiated by the user, such as when a user posts their status in their activity fee. As an example, a system initiated the event is an event that is initiated by the system. One example of an event initiated by the system is referred to as a commerce event, such as when the particular user purchases of products, typically via the system. Accordingly, the event manager 502 produces one or more followed post that are supplied to one or more data followers. The event manager 502 can receive followers data that identifies the one or more data followers for the events associated with the particular user.

The event processing system 500 can also include a feed manager 504 that is associated with a representative follower. In other words, in one environment, each follower of the particular user will have an associated feed manager 504. The feed manager 504 receives the followed post from the event manager 504. However, the feed manager 504 can serve to restrict the quantity of incoming posts that are presented to the representative follower. In particular, the feed manager 504 can receive follower criteria. The follower criteria is criteria that can be used by the feed manager 504 to restrict, limit or filter the incoming followed post. The follower criteria can be automatically determined by the system, set by user selections, or some combination thereof. Those of the followed post that the feed manager 504 permits to be delivered to the representative follower can be supplied by the feed manager 504 to a follower's user page where the followed post can be presented. For example, followed post can be presented in the follower's user page in an activity feed.

FIG. 5B is a block diagram of an event processing system 550 according to another embodiment. The event processing system 550 includes an activity event manager 552 that receives user status events from a particular user. The event processing system 550 also includes a commerce event manager 554 that receives commerce events from the particular user. The activity event manager 552 determines one or more followers that are to receive a followed status post concerning the particular user. The activity event manager 552 can receive follower's data that identifies one or more users that are following the particular user. The followed status post from the activity event manager 552 is directed to one or more feed managers 556. In this environment, each of the different users can utilize a different one on the feed managers 556. Hence, the followed status post from the activity event manager 552 can be delivered to the appropriate one or more of the feed managers 556 corresponding to those of the followers of the particular user.

The one or more feed managers 556 can process the incoming posts that it receives. For example, the feed manager 556 can receive a followed status post from the activity event manager 552 and can receive followed commerce post from the commerce event manager 554. Each of the feed managers 556 can separately evaluate whether to present a post on the corresponding follower's user page. That is, for a given incoming posts, the feed manager 556 can evaluate whether the post should be presented on the follower's user page. The follower criteria for the corresponding user can be utilized by the feed manager 556 make a intelligent decision on whether or not to present an incoming post on the follower's user page. The post, if presented on the follower's user page, can for example be presented as indicated in the activity region 401, such as recent activity 402, 413, 428 or 444, such as illustrated in FIG. 4.

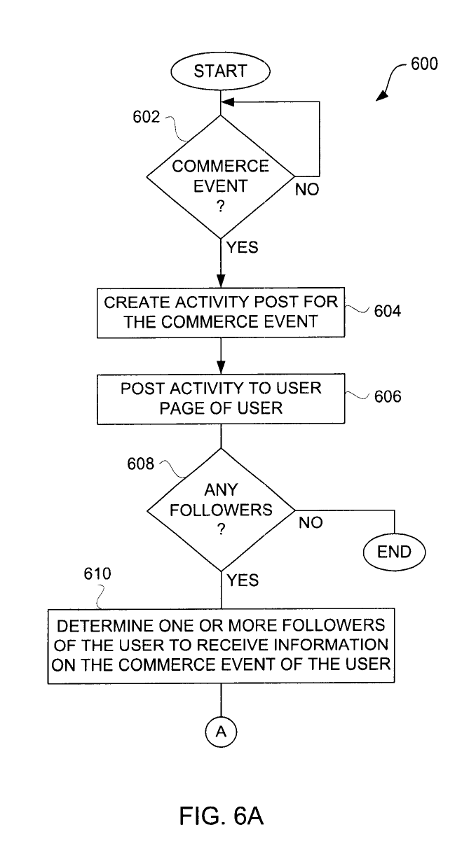

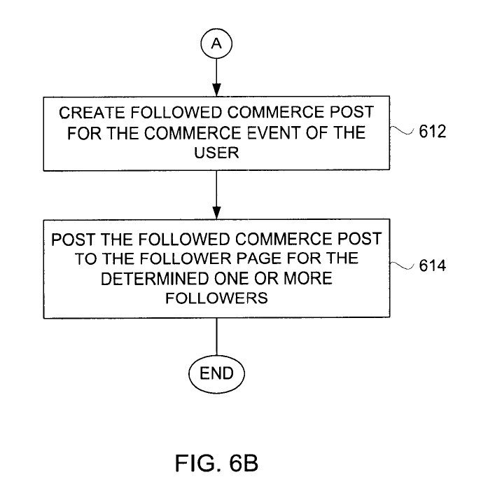

FIGS. 6A and 6B are flow diagrams of a commerce posting process 600 according to one embodiment. The commerce posting process 600 can, for example, be performed by a server, such as the central server 102 illustrated in FIG. 1.

The commerce posting process 600 can begin with a decision 602 that determines whether a commerce event has been received. The commerce event is associated with a user. Typically, the commerce event results from a purchase, namely, an online purchase, of a product by the user. The product can be a digital product, such as a digital media asset or digital program, that can be delivered electronically (e.g., downloaded) or a physical product that can be delivered by courier (e.g., Federal Express, Universal Parcel Service, etc.). When the decision 602 determines that a commerce event has not been received, the commerce posting process 600 can await such an event. Once the decision 602 determines that a commerce event for the user has been received, an activity post for the commerce event can be created 604. The activity post can include at least a textual message explaining the purchase by the user. In one implementation, the activity post is computer generated (e.g., by the server) without assistance from the user (i.e., system generated). In another implementation, the activity post is partially computer generated and the user contributes to the activity post. Besides a textual message, the activity post can also include a graphical component, such as an image of the product that has been purchased. After the activity post has been created 604, the activity post can be posted 606 to a user page of the user.

Following posting 606 of the activity post, a decision 608 can determine whether there are any followers of the user. Typically, a follower of the user decides to follow the user to receive activity posts associated with the user. Often, the user will have a user page and any followers will also have a user page. If the decision 608 determines that there are no followers of the user, the commerce posting process 600 can end. However, on the other hand, if the decision 608 determines that there are followers of the user, one or more followers of the user that are to receive information concerning the commerce event can be determined 610. Here, in this embodiment, the information concerning the commerce event is provides as a post in an activity feed of the one or more followers. More specifically, a followed commerce post can be created 612 for the commerce event of the user. In one embodiment, creation 612 of the commerce post can be by the server (e.g., computer generated).

The followed commerce post can then be posted 614 to the follower page for the determined one or more followers. In one implementation, each of the one or more followers can receive the same followed commerce post. In another implementation, the one or more followers can receive different followed commerce posts. Nevertheless, the followed commerce post will be posted 614 to all, some or none of the one more followers for the user. After the followed commerce post has been posted 614, the commerce posting process 600 can end.

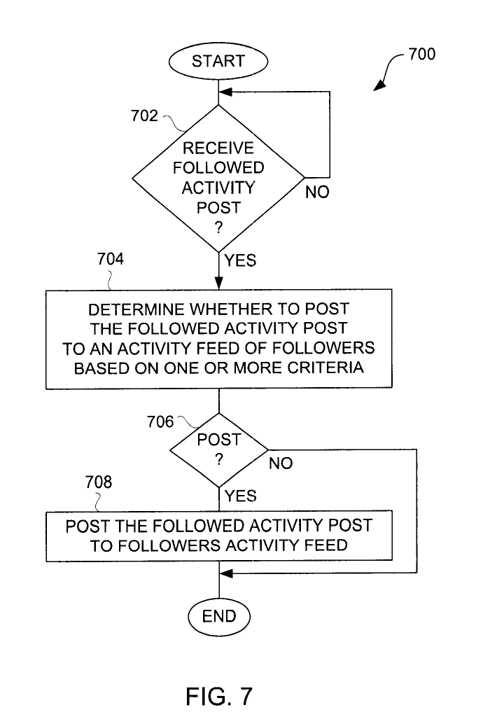

FIG. 7 is a flow diagram of a followed activity posting process 700 according to one embodiment. The followed activity posting process 700 can, for example, be associated with processing corresponding to block 610 illustrated in FIG. 6A.

The followed activity posting process 700 can begin with a decision 702 that determines whether a followed activity post has been received. When the decision 702 determines that a followed activity post has not been received, the followed activity posting process 700 can await receipt of a followed activity post. Alternatively, when the decision 702 determines that a followed activity post has been received, the followed activity posting process 700 can determine 704 whether to post the followed activity post to an activity feed of one or more of the followers based on one or more criteria. A decision 706 can then determine whether the followed activity post is to be posted to one or more of the followers. When the decision 706 determines that the followed activity post is to be posted, then the followed activity post can be posted 708 to the activity feed of each of the one or more followers that has been determined 704 to receive the feed. Following block 708, as well as following the decision 706 when the followed activity post is not to be posted, the followed activity posting process 700 can end.

### Recommendations

Another aspect of the invention can pertain to a networked system and method for providing recommendations to users of the networked system. The networked system can provide media content and/or a social network to users. For example, the networked system can pertain to a media system incorporating social networking. The networked system can evaluate users and/or activities to determine when and to which users a recommendation should be provided. Even if a recommendation is provided to more than one user, the recommendation can be different for different users (or groups of users).

The recommendations can be for products, services or persons. For example, one type of recommendations can pertain to suggesting to a particular user other users that the particular user might be interested in being online friends with or “following”. Such recommendations could be evaluated based at least in part on correlations between user's media profiles or media interests (e.g., media profile, media events, media collection, and/or media usage). The correlations amongst users can also be depicted for users. As further examples, other types of recommendation can pertain to recommendations of products, services or events.

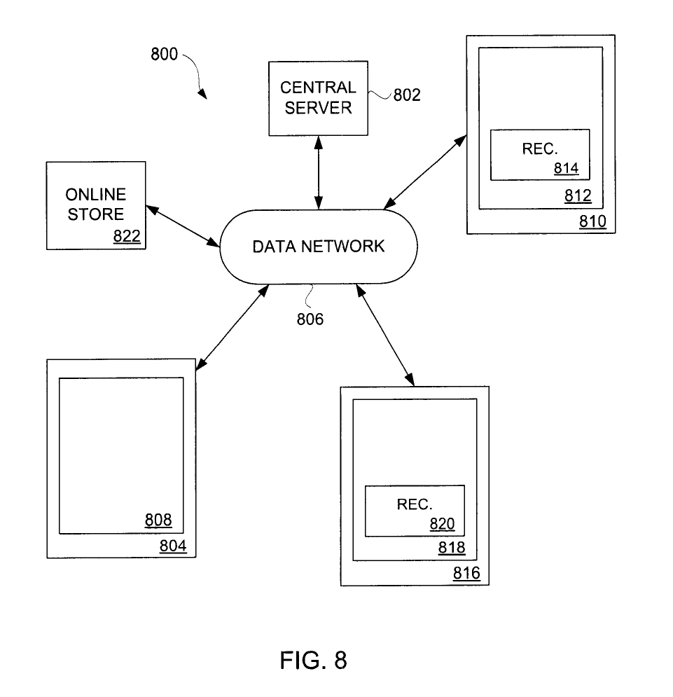

FIG. 8 is a block diagram of a networked system 800 according to one embodiment. The networked system 800 can provide media content and/or a social network to users. The networked system 800 can include a central server 802. The central server 802 includes one or more processing units to perform computer program code stored on one or more data storage devices. The central server 802 can also store profile and other information pertaining to a plurality of users. Users of the networked system 800 can allow access their profile as well as profiles other users. Additionally, users of the networked system 800 can allow users to follow other users. Still further, the social activity following system 800 can provide recommendations of (i) other users that one might be interested in following, or (ii) products, services or events.

The networked system 800 also supports a plurality of user computers that can be associated with users. In particular, the networked system 800 illustrates a user computer 804 that can couple to a data network 806. The central server 802 is also coupled to the data network 806. The user computer 804, though interaction with the central server 802, is capable of presenting an electronic page 808. For example, the user computer 804 can include a display that is capable of presenting the electronic page 808. The user computer 804 receives the electronic page 808 from the central server 802, and then presents the electronic page 808 on the display of the user computer 804. According to one embodiment, the electronic page 808 can include a profile or an activity associated with its user or friends (followers) of the user.

The networked system 800 can also support a plurality of follower computers that can be associated with users that follow other users. In the example illustrated in FIG. 8, there are two followers of the user associated with the user computer 804. Specifically, the networked system 800 can support a follower computer 810 having a display capable of presenting a follower page 812. The follower page 814 can include a recommendation 816. The recommendation 816 is provided for the user of the follower computer 810 and can, among other things, recommend a user, a product, a service or an event. The recommendation 816 can be provided to the follower computer 816 due to a user activity at the user computer. As an example, the recommendation 816 could be triggered by user activity associated with at least the user of the user computer 804 or by user activity associated with the user of the user computer 804 as well as user activity associated with various other users also being followed.

Additionally, the networked system 800 can support a follower computer 816 having a display capable of presenting a follower page 818. The follower page 818 can include a recommendation 820. The recommendation 820 is provided for the user of the follower computer 816 and can, among other things, recommend a user, a product, a service or an event. The recommendation 820 can be provided to the follower computer 816 due to a user activity at the user computer. As an example, the recommendation 820 could be triggered by user activity associated with at least the user of the user computer 804 or by user activity associated with the user of the user computer 804 as well as user activity associated with various other users also being followed.

More generally, the follower pages 814, 820 are electronic pages. The follower computers 810, 816 respectively receive electronic pages for the follower pages 812, 818, and then respectively present the electronic pages on the displays of the follower computers 810, 816.

The central server 802 can manage the activity feeds for the various users, including followers. That is, when the user activity feed within user activity region 810 is updated (e.g., by including a new activity posting), the updated user activity can also propagate to the followers of the user. In such case, the corresponding follower pages 814, 820 can be updated to include followed user activity corresponding to the updated user activity within the activity feeds 812, 822. However, it should be noted that a follower typically follows a plurality of different users. As such, the activity feeds presented on a follower page typically integrate activity from a plurality of different users as well as activity associated with the corresponding follower (user).

The networked system 800 can also support an online store 822. The user can interact with the online store 822 to engage in e-commerce transactions to purchase products or services. In one embodiment, the online store 822 can facilitate purchase of electronic products (or digital assets), such as digital media or software programs. As one example, the online store 822 can pertain to an online media store from which users can purchase numerous media items. As another example, the online store 822 can pertain to an online application store from which users can purchase numerous application programs. As discussed in detail below, if a purchase occurs from the online store 822 by the user, an activity event can be produced. The activity event can be used to trigger a recommendation to one or more other users. The central server 802 can generate and distribute one or more recommendations to various other users. The users receiving recommendations via their user computers can be restricted to followers of the user, or to other correlated users. Consequently, the follower pages 812, 818 of the follower pages 810, 816 can receive a recommendation (e.g., affiliated or induced by the user) and cause a recommendation to be presented in the activity feed associated with the follower pages 810, 816.

Although the central server 802 and the online store 822 are depicted in FIG. 8 as being separate devices, it should be understood that the central server 802 and the online store 822 can both be hosted on the same device (e.g., server).

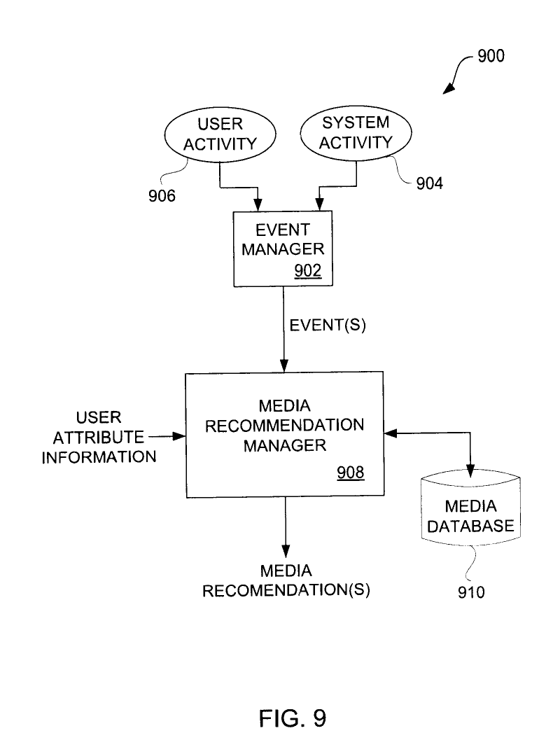

FIG. 9 is a block diagram of a recommendation system 900 according to one embodiment. The recommendation system 900 can be part of a networked system, such as a networked media system which may include social networking.

The recommendation system 900 can include an event manager 902 and a media recommendation manager 908. The event manager 902 can receive system activity 904 and user activity 906. The system activity 904 can pertain to system-initiated events. The user activity 906 can pertain to events due to user activity with the networked media system. The event manager 902 can operate to determine whether or not the events of the received system activity 904 of the user activity 906 are to be forwarded to, or otherwise used to trigger, the media recommendation manager 908. The media recommendation manager 908 can provide media recommendations that can be supplied to one or more users of the networked media system. With respect to media recommendations, the recommendations can be for media, such as music, movies, games, books, software applications, or events.

The media recommendation manager 908 can also receive user attribute information which can be used to identify one or more users to receive recommendations. The user attribute information can pertain to user profile, who followed, who follows, user media collection, user preferences or settings, user ratings, or user reviews. For example, user may provide preferences or settings that indicate to what extent they are interested in receiving notifications. The networked media system can also maintain profiles, including media interest information, for users. The profiles can be used by the media recommendation manager 908 in making recommendations. User affinity with other users can also be considered with providing recommendations.

Still further, the media recommendation manager 908 can access a media database 910. The media database 910 can store information for a plurality of media items. The media recommendations can contain or link to information provided by the media database 902. The media recommendations can facilitate acquisition of additional information concerning the recommendation, which could be a media recommendation. The media recommendations can facilitate acquisition of the media being recommended by the recommendation.

The system activity 904 can also be referred to as synthetic events. The system activity 904 can pertain to events or activity conditions known to the system. There are many different events or activity conditions that can initiate recommendations. As one example, the recommendation system 900 can know that of a concert nearby that fits user A's profile, and thus the recommendation system 900 can recommend the concert to user A, which can indicate that certain of user's friends are already going to the concert. As another example, the recommendation system 900 can be aware of recent posting activity or reviews that suggests that a topic is “hot”, and can then offer a recommendation to purchase media related to the “hot” topic. Such a recommendation can not be provided if the user already has the recommended media.

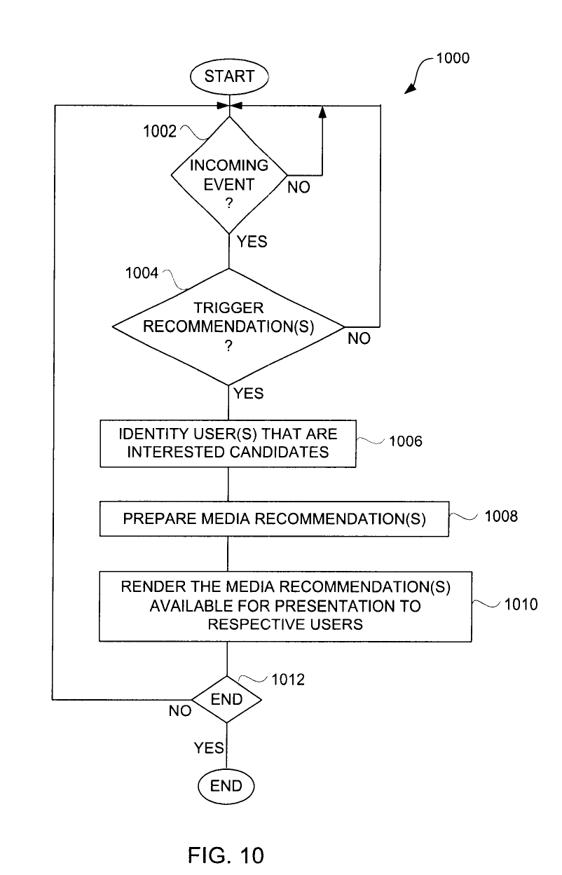

FIG. 10 illustrates a flow diagram of a media recommendation process 1000 according to one embodiment. The media recommendation process 1000 can be performed by a computing device, such as the central server 802 illustrated in FIG. 8 or the recommendation system 900 illustrated in FIG. 9.

The media recommendation process 1000 can begin with a decision 1002 that determines whether an event is incoming. When the decision 1002 determines that an event is not incoming, the media recommendation process 1000 can await such an event. Once the decision 1002 determines that an incoming event has been received, a decision 1004 can determine whether to trigger one or more recommendations. When the decision 1000 for determines that the incoming event does not trigger one or more recommendations, the processing by the media recommendation process 1000 returns to repeat the decision 1002 so that subsequent events can be similarly processed.

On the other hand, when the decision 1004 determines that the incoming event does trigger one or more recommendations, one or more users that are interested candidates can be identified 1006. The one or more interested candidates can be identified 1006 based on their profiles (e.g., media interests, user settings, and the like), their activity (e.g. postings, reviews, ratings, purchase history), and the like. After the one or more users that are interested candidates have been identified 1006, one or more media recommendations can be prepared 1008. Although all of the one or more interested candidates can received the same media recommendation, the media recommendations can be different (e.g., customized) for different ones (or groups) of the interested candidates. Thereafter, the one or more media recommendations can be rendered 1010 available for presentation to respective users. The recommendations can thus be provided to the users that are interested candidates in response to appropriate incoming events. For example, the recommendations can be provided to user that are the interstate candidates by presenting the recommendation in an electronic page rendered on the user's computing device.

Following the block 1010, a decision 1012 can determine whether the media recommendation process 1000 should end. When the decision 1012 determines that the media recommendation process 1000 should not and, the processing for the media recommendation process 1000 can return to repeat the decision 1002 so that subsequent events can be similarly processed. Alternatively, when the decision 1012 determines that the media recommendation process 1000 should end, then the media recommendation process 1000 can end.

The media recommendations as discussed above with respect to FIGS. 9 and 10 can pertain to products (e.g., songs, albums, movies, books, applications, games, etc.), services (music lesions, training, schooling, etc.) or events (e.g., concerts, performances, competitions, meetings, etc.). In another embodiment, the recommendations can be to other users. With respect to recommendations to other users, the networked media system which includes social networking can operate to make recommendations for other users a particular user might want to follow (friend). The users can be classified as ordinary users (denoted as “persons”) or artists. Typically, the artists have media content available via the network media system for playback (e.g., streaming), preview or purchase.

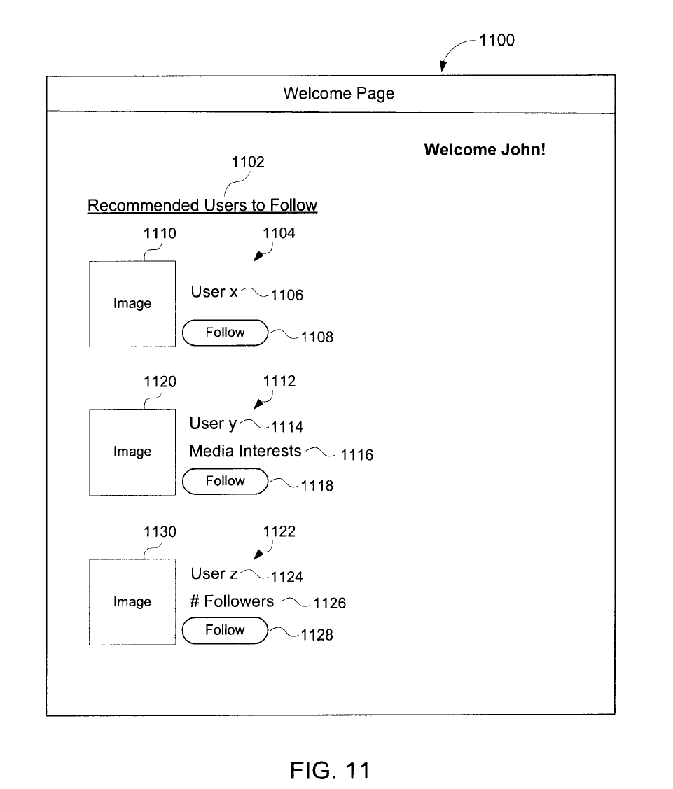

FIG. 11 illustrates an exemplary welcome page 1100 according to one embodiment. The networked media system can operate to present the welcome page 1100 on a computing device associated with a particular user. In this example, the particular user is a registered user with the networked media system who is registered under the name of “John”.

The welcome page 1100 is simplified but does include at least one or more recommendations for one or more users that the particular user might follow. Specifically, the welcome page 1100 includes recommended users to follow section 1102. Within the recommended users to follow section 1102, there is depicted three (3) different users that had been identified as users that the particular user may desire to follow. For example, the networked media system may have correlated media profiles to determine that the users being recommended have similar media tastes as does the particular user. As another example, the system may correlate activity data amongst the users to determine the users to be recommended. The activity can pertain to user purchase activity, and user rating activity, user review activity, or user posting activity. As illustrated in FIG. 11, three (3) users being recommended are presented in the welcome page 1100 (or some other suitable page). A first recommended user 1104 can be presented with a username 1106, a user interface control 1108 to initiate following of the first recommended user 1104, and an image 1110 associated with the first recommended user 1104. A second recommended user 1112 is presented with a username 1114, one or more media interests indications 1116, a user interface control 1118 to initiate following of the second recommended user 1112, and an image 1120 associated with the second recommended user 1112. A third recommended user 1122 is presented with a username 1124, a number of followers 1126, a user interface control 1128 to initiate following of the third recommended user 1122, and an image 1130 associated with the third recommended user 1122. The information provided for each of the first recommended user 1104, the second recommended user 1112 and the third recommended user 1122. For example, the information presented on the welcome page 1100 for the different types of users being recommended can be different.

Although FIG. 11 provides the one or more recommended users on the welcome page 1100, it should be noted that the recommendations provided therein can be presented on any portion of an electronic page.

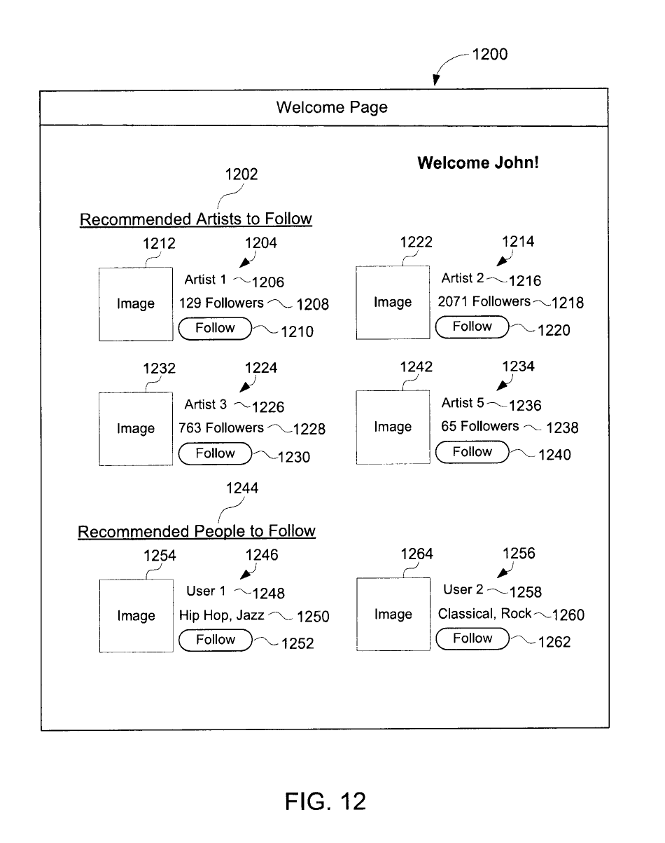

FIG. 12 illustrates an exemplary welcome page 1200 according to one embodiment. The networked media system can operate to present the welcome page 1200 on a computing device associated with a particular user. In this example, the particular user is a registered user with the networked media system who is registered under the name of “John”. The welcome page 1200 is, for example, a more specific implementation of the welcome page 100 illustrated in FIG. 11.

The welcome page 1200 is simplified but does include recommendations for one or more users that the particular user might follow. The welcome page 1200 identified four (4) recommended artists and two (2) recommended persons to follow.

More specifically, the welcome page 1200 can include a recommended artists to follow section 1202. Within the recommended artists to follow section 1202, there are depicted four (4) different artists that have been identified as artists that the particular user may desire to follow. For example, the networked media system may have correlated media profiles or have considered user's media collection or listening habits to determine that the artists being recommended are likely of interest to the user. Specifically, the recommended artists to follow section 1202 identifies and presents information about each of the artists being recommended. For a first artist 1204, a name 1206, a number of followers 1208 of the first artist, a user interface control 1210 to initiate following the first artist, and an image 1212 associated with the first artist can be displayed. For a second artist 1214, a name 1216, a number of followers 1218 of the second artist, a user interface control 1220 to initiate following the second artist, and an image associated with the second artist can be displayed. For a third artist 1224, a name 1226, a number of followers 1228 of the third artist, a user interface control 1230 to initiate following the third artist, and an image associated with the third artist can be displayed. For a fourth artist 1234, a name 1236, a number of followers 1238 of the fourth artist, a user interface control 1240 to initiate following the fourth artist, and an image associated with the fourth artist can be displayed.

The welcome page 1200 can also include a recommended people to follow section 1244. Within the recommended people to follow section 1244, there is depicted two (2) different users that have been identified as people that the particular user may desire to follow. For example, the networked media system may have correlated media profiles or have considered user's media collections, postings, reviews or listening habits to determine that the users being recommended may be of interest to the user. Specifically, the recommended people to follow section 1244 identifies and presents information about each of the users being recommended. For a first user 1246, a name 1248, genres of interest to the first user 1250, a user interface control 1252 to initiate following the first user, and an image 1254 associated with the first user can be displayed. For a second user 1256, a name 1258, genres of interest to the second user 1260, a user interface control 1262 to initiate following the second user, and an image 1264 associated with the second user can be displayed.

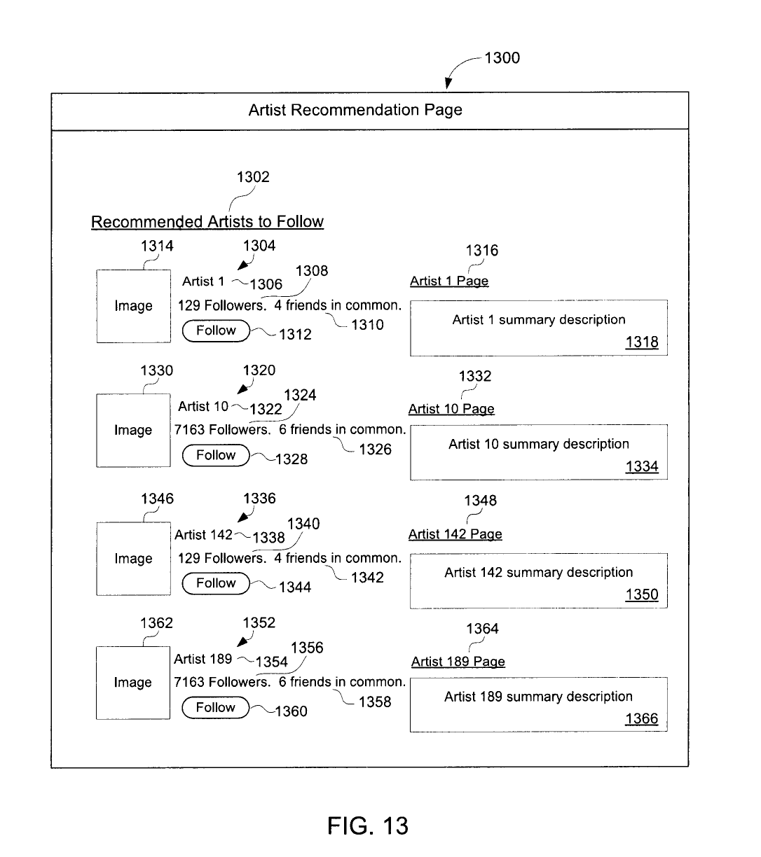

FIG. 13 illustrates an exemplary artist recommendation page 1300 according to one embodiment. The networked media system can operate to present the artist recommendation page 1300 on a computing device associated with a particular user that is to receive the recommendations. In this example, the artist recommendations are the primary purpose of the page.

The artist recommendation page 1300 includes a plurality of artist recommendations being recommended for a particular user. Specifically, the artist recommendation page 1300 includes a recommended artists to follow section 1302. Within the recommended artists to follow section 1302, there is depicted four (4) different artists that have been identified as artists that the particular user may desire to follow. For example, the networked media system may have consider the particular user's musical tastes (e.g., genres of interest), media collections, media usage, review, and the like to determine that the artists being recommended are likely of interest to the particular user. As another example, the system may correlate activity data amongst the users to determine artists to be recommended. The activity can pertain to user purchase activity, and user rating activity, user review activity, or user posting activity.

As illustrated in FIG. 13, four (4) artists are being recommended are presented in the artist recommendation page 1300 (or some other suitable page). A first recommended artist 1304 can be presented with an artist name 1306, a number of followers 1308, a number of friends in common 1310, a user interface control 1312 to initiate following of the first recommended artist 1304, and an image 1314 associated with the first recommended artist 1304. In addition, an artist 1 page link 1316 (e.g., hyperlink) can be presented on the artist recommendation page 1300 to facilitate access to an artist page containing more detailed information on the artist. Additionally, for the first recommended artist 1304, a short description region 1318 can be displayed within the artist recommendation page 1300 to provide a summary description on the first artist.

A second recommended artist 1320 can be presented with an artist name (“Artist 10”) 1322, a number of followers 1324, a number of friends in common 1326, a user interface control 1328 to initiate following of the second recommended artist 1320, and an image 1330 associated with the second recommended artist 1320. In addition, an artist 10 page link 1332 (e.g., hyperlink) can be presented on the artist recommendation page 1300 to facilitate access to an artist page containing more detailed information on the artist. Additionally, for the second recommended artist 1320, a short description region 1334 can be displayed within the artist recommendation page 1300 to provide a summary description on the second artist.

A third recommended artist 1336 can be presented with an artist name (“Artist 142”) 1338, a number of followers 1340, a number of friends in common 1342, a user interface control 1344 to initiate following of the third recommended artist 1336, and an image 1346 associated with the third recommended artist 1336. In addition, an artist 142 page link 1348 (e.g., hyperlink) can be presented on the artist recommendation page 1300 to facilitate access to an artist page containing more detailed information on the artist. Additionally, for the third recommended artist 1336, a short description region 1350 can be displayed within the artist recommendation page 1300 to provide a summary description on the third artist.

A fourth recommended artist 1352 can be presented with an artist name (“Artist 189”) 1354, a number of followers 1356, a number of friends in common 1358, a user interface control 1360 to initiate following of the fourth recommended artist 1352, and an image 1362 associated with the fourth recommended artist 1352. In addition, an artist 189 page link 1364 (e.g., hyperlink) can be presented on the artist recommendation page 1300 to facilitate access to an artist page containing more detailed information on the artist. Additionally, for the fourth recommended artist 1352, a short description region 1366 can be displayed within the artist recommendation page 1300 to provide a summary description on the fourth artist.

### Profile Creation & Editing

Another aspect disclosed herein pertains to creation or editing of profiles. As noted above, profiles can be used with an online media system. A profile for a user can include information about users, including a media profile that represents the media interests of the user. The profiles can also facilitate social networking via the online media system. Additional discussion of profiles is provided below.

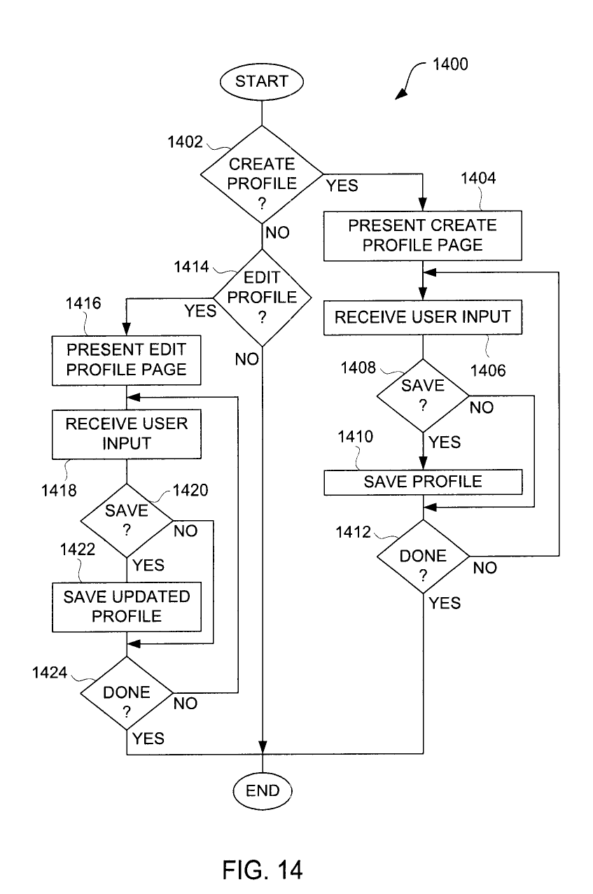

FIG. 14 is a flow diagram of a profile setting process 1400 according to one embodiment. The profile setting process 1400 can, for example, be performed by a computing device. The computing device can be a server, such as the central server 102 illustrated in FIG. 1 and/or a user computer, such as the user computers 104, 112 and 118 illustrated in FIG. 1.

The profile setting process 1400 can be used to create a profile for a new user, or to edit a profile that has been previously created. The profile setting process 1400 can begin with a decision 1402 that determines whether a profile is to be created.

When the decision 1402 determines that a profile is to be created, a create profile page can be presented 1404. Here, for example, the computing device can cause the create profile page to be displayed. User input provided by a user with respect to the create profile page can then be received 1406. The user input is used to form the profile for the user. A decision 1408 can also determine whether the profile being created should be saved. When the decision 1408 determines that the profile should be saved, the profile that is being created using the create profile page can be saved 1410. Alternatively, when the decision 1408 determines that the profile being created to not be saved, the block 1410 can be bypassed. Following the block 1410, or its being bypassed, a decision 1412 can determine whether the creation of the profile is complete (or done). When the decision 1412 determines that the creation of the profile page has not been completed, the profile setting process 1400 can return it to repeat the block 1406 and subsequent blocks so that the creation of the profile page can continue. Once the decision 1412 determines that the creation of the profile page has completed, the profile setting process 1400 can end.

On the other hand, when the decision 1402 determines that a profile is not to be created, a decision 1414 can determine whether a profile is to be altered (i.e., edited). When the decision 1414 determines that a profile is to be altered, an edit profile page can be presented 1416. Here, for example, the computing device can cause the edit profile page to be displayed. User input with respect to the edit profile page can then be received 1418. The user input is used to edit an existing profile for the user.

A decision 1420 can determine whether the profile being altered should be saved. When the decision 1420 determines that the profile being altered should be saved, the profile that is being altered using the edit profile page can be saved 1422. Alternatively, when the decision 1420 determines that the profile being altered is not to be saved, the block 1422 can be bypassed. Following the block 1422, or its being bypassed, a decision 1424 can determine whether the alteration to the profile is complete (or done). When the decision 1424 for determines that the alteration of the profile page has not completed, the profile setting process 1410 can return to repeat the block 1418 and subsequent blocks so that the alteration to the profile page can continue. Once the decision 1424 for determines that the alteration of the profile page has completed, the profile setting process 1400 can end. Additionally, when the decision 1414 determines that a profile is not to be altered, the profile setting process 1400 can also end.

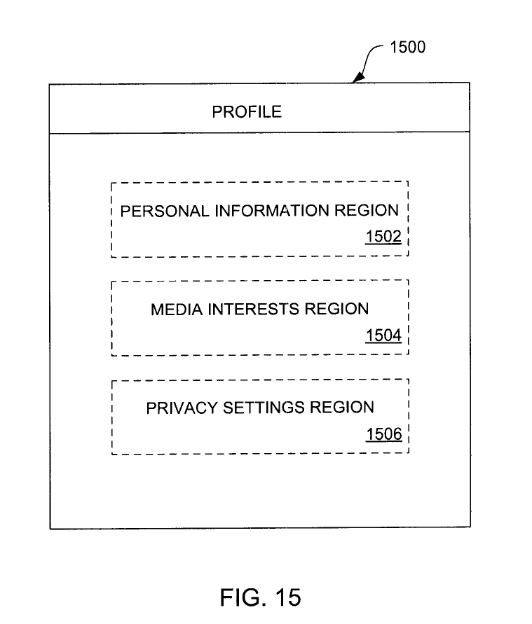

FIG. 15 is a view of a general profile page 1500 according to one embodiment. The profile page 1500 can provide a representation of a user profile for at least one user. In one embodiment, user profile can be associated with a user of a social networking system. For example, the social network system can support ordinary users (consumer-users) as well as content provider users (e.g., artists, distributors), and each of which can form a profile that can be accessible via the social networking system. The social networking system can be part of an online media system.

The generalized profile page 1500 can represent a profile, namely, an electronic profile that can be maintained and presentable by a social network system. The generalized profile page 1500 is initially created by a user to serve as that user's profile. Once a profile has been formed, the user is able to subsequently edit the profile to thereby update the generalized profile page 1500. The generalized profile page 1500 can include a variety of different regions that can contain different types of information or data pertaining to the user associated with the profile. For example, as illustrated in FIG. 15, the profile page 1500 can include a personal information region 1502, a media interests reaching 1504, and a privacy settings reaching 1506. The personal information region 1502 can provide for user entry of personal information used to describe or represent the user with the social networking system. The media interests region 1504 can include media information that is representative of the user. More generally, the media interests region 1504 can represent any type of digital media asset which can be identified and used as representative of what the user likes. The privacy settings region 1506 can provide user selectable controls for controlling privacy options with respect to one's profile.

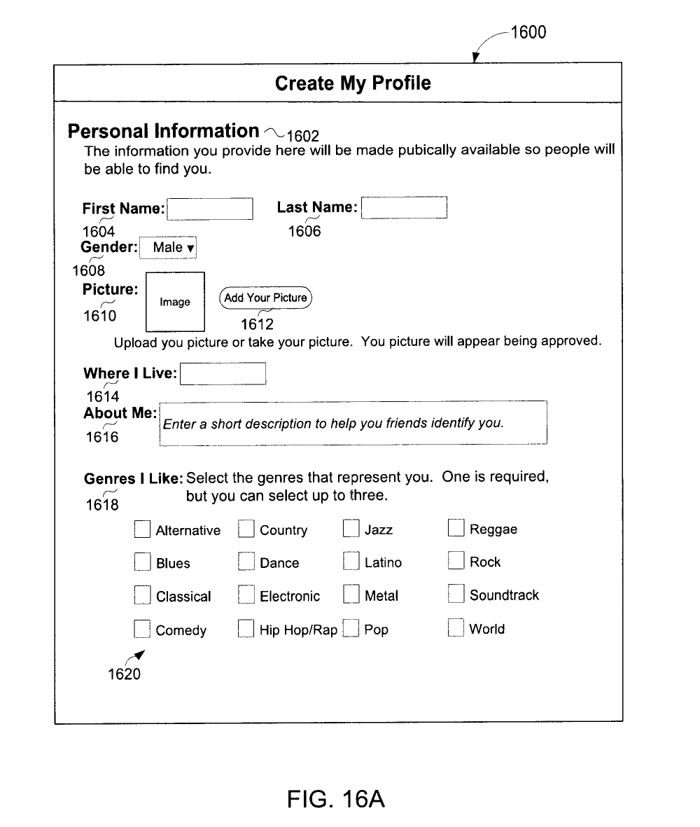

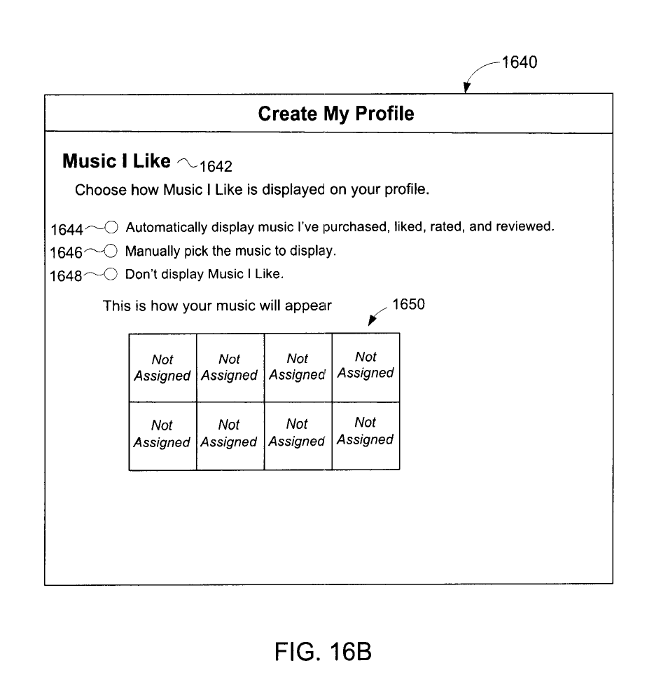

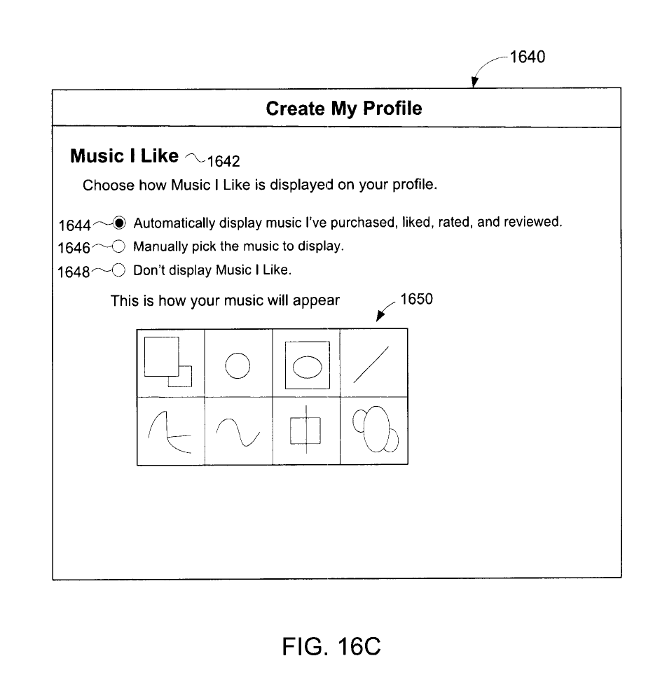

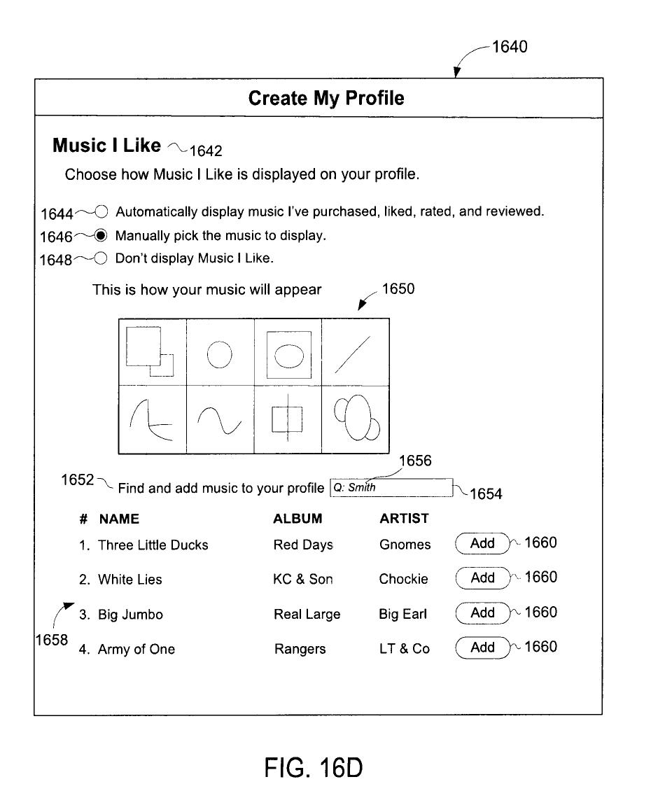

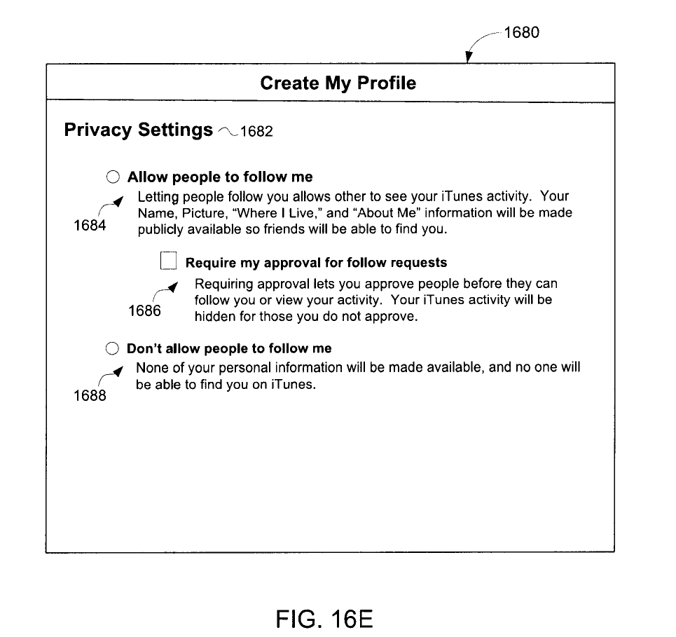

FIG. 16A is a view of a representative profile creation screen 1600 according to one embodiment. The profile creation screen 1600 can represent one embodiment of the personal information region 1502 of the general profile page 1500 illustrated in FIG. 15.

The profile creation screen 1600 includes a personal information region 1602. A user can interact with the profile creation screen 1600 to provide personal information about the user that will be made publicly available on a social networking system. In the example illustrated in FIG. 16A, the personal information region 1602 can allow a user to designate a first name 1604, a last name 1606, and a gender 1608. The personal information region 1602 can also allow the user to provide a picture 1610 pertaining to the user. A user interface control 1612 can assist the user in locating an image to be uploaded for use as the picture 1610 associated with the profile for the user. In one implementation, the social networking system can require approval of the uploaded image prior to being made available as one's picture on the social networking system.

In addition, the personal information region 1602 can also include residential information 1614 (e.g., denoted “Where I Live”) for the user, such as city and state. Still further, the personal information region 1602 can include a narrative section 1616 (e.g., denoted “About Me”) where the user can provide a short description about themselves.

Furthermore, the profile creation screen 1600 can also include a genre selection section 1618 that assists the user in specifying genres of media (e.g., music) that they would associate with themselves. In the particular example depicted in FIG. 16A, the user can select from one to three predetermined genres that will be utilized in their profile. The predetermined genres available for selection can be presented in a table or list format 1620. A few examples of predetermined genres for music are: Alternative, Blues, Classical, Comedy, Country, Dance, Electric, Hip-hop/rap, Jazz, Latino, Metal, Pop, Reggae, Rock, Soundtrack and World.

FIG. 16B is a view of another profile creation screen 1640 according to one embodiment. The profile creation screen 1640 can represent a new screen or page, or can alternatively represent a portion of the same screen or page that contains the personal information 1602 presented in the profile creation screen 1600 illustrated in FIG. 16A.

The profile creation screen 1640 includes a media interests region 1642 that is denoted “Music I like”. In the media interests region 1642, the user is able to associate media items, such as musical items, that they like with their profile. Additionally, the selection for the musical items can be automatic or manual. A first user control 1644 can be selected by the user to cause the musical items to be automatically selected. The automatic selection can be performed, for example, based on music that user has purchased, “liked”, rated or reviewed. A second user control 1646 can be selected by the user to facilitate manual selection of the musical items. In such case, although not shown in FIG. 16B, an additional user interface control can be further added to the profile creation screen 1640 to assist the user in identifying musical items. For example, the additional user interface control can be a search or browse functional control. A third user interface control 1648 can be selected by the user to indicate that the user does not want the media interests region 1642 of their profile to designate any particular media items that might represent them. The profile creation screen 1640 can also include a media profile depiction 1650. The media profile depiction 1650 can provide a representation of a predetermined number of media items, namely, musical items, that have been selected to be included within the media profile. The media profile depiction 1650 can not only facilitate selection of the media items for the media profile but also can present the media profile being created to the user so that the user understands how the media profile will appear to others accessing their profile using the social networking system. As depicted in FIG. 16B, the media profile depiction 1650 can be presented in any grid-like fashion is empty with all of a predetermined number (e.g., 8) of media slots being vacant, since no media items are presently assigned.

FIG. 16C is another view of the profile creation screen 1640 illustrated in FIG. 16B according to one embodiment. Here, the profile creation screen 1640 has indicated that the user has selected the first user control 1644 to request that the music profile be generated automatically. Consequently, the media profile depiction 1650 has been automatically updated to include the predetermined number of media items within the media profile. In this example, each of the media items being assigned to the media profile is depicted as an image, namely, an album cover art associated with the media item (e.g., song). It should be noted that if automatic selection does not yield enough unique images to complete the media profile, media profile can include designators for empty slots (e.g., empty slots in FIG. 16B).

Although FIGS. 16B and 16C provide for selection of media items, such as songs, it should be understood that in the media interests region 1642 can alternatively allow for the selection of any of a variety of different digital media assets. For example, the selections could pertain to selections of any one or more songs, albums, software applications, movies, electronic books, games and the like.

FIG. 16D is another view of the profile creation screen 1640 illustrated in FIG. 16B according to one embodiment. Here, the profile creation screen 1640 has indicated that the user has selected the second user control 1646 to request that the music profile be generated manually. Consequently, the media profile depiction 1650 has been manually created by the user selecting the predetermined number of media items to be included within the media profile. In this example, each of the media items being assigned to the media profile is depicted as an image, namely, an album cover art associated with the media item (e.g., song). It should be noted that if manual selection has not selected enough media items (with unique images) to complete the media profile, media profile can include designators for empty slots (e.g., empty slots in FIG. 16B). Also, in this embodiment, the profile creation screen 1640 can include a search designator 1652 which denotes a search functional control 1654 (e.g., search text box). In this example, a search string “Smith” has been entered in the search functional control 1654. Still further, search results 1658 of a search for media items in accordance with the search string (e.g., matching the search string) can be presented in the profile creation screen. The search results 1658 are presented in a list or table (or grid). In the embodiment illustrated in FIG. 16D, the media items within the search results 1658 are presented in a table (or grid) having name, album and artist for each of the media items. Additionally, a user control 1660 (denoted e.g., “Add”) can be provide to assist a user in adding the corresponding one of the media items in the table to the media profile depiction 1650.

Although FIGS. 16B and 16C provide for selection of media items, such as songs, it should be understood that in the media interests region 1642 can alternatively allow for the selection of any of a variety of different digital media assets. For example, the selections could pertain to selections of any one or more songs, albums, software applications, movies, electronic books, games and the like.

Various additional features associated with media profile creation are discussed below. For example, the media profile depiction 1650 illustrated in FIG. 16C can be presented in an grid-like fashion that depicts images associated with particular media items. Once the media profile depiction 1650 has been displayed, the user can further manipulate the media profile by manual interaction with the displayed images, if so desired. For example, that user could select one of the images pertaining to a media item in the media profile depiction 1650 and move it to another position within the displayed media profile depiction 1650 (e.g., to another grid position with a drag-and-drop action). For example, the user might want the first grid position to the most significant and correspond to their currently most favorite media item.

Another feature that can be utilized by user when switching between manual or automatic creation of a media profile. Here, the system can store prior selections for possible subsequent use. For example, if the user has made one or more several manual selections for their media profile and then selects to have the media profile automatically created, the manual selections can be stored (e.g., in a database) prior to automatically creating the media profile. If the user later returns to manual selection, the previously saved manual selections can be recalled and used to at least partially form the media profile. Also, switching between automatic selection to manual selection, can store those selections previously automatically determined. In any case, if prior selections are used, the prior selection can be easily deleted by the user from the media profile.

Still another feature for the media profile depiction 1650 is that if a user interacts with the media profile depiction 1650 to direct a pointing device over one of the images (e.g., cursor positioned over image), the computing device can pop-up an information box on or adjacent the image to present media information. For example, if the media item is a song, the information box being popped-up can provide the name of the song, the album including the song, and the artist.

FIG. 16E is a view of another profile creation screen 1680 according to one embodiment. The profile creation screen 1680 can represent a new screen or page, or can alternatively represent a portion of the same screen or page that contains the personal information 1602 presented in the profile creation screen 1600 illustrated in FIG. 16A and/or the media interests region 1642 presented in the profile creation screen 1640 illustrated in FIG. 16B.

The profile creation screen 1680 includes a privacy settings region 1682 that is designated “privacy settings”. The privacy settings region 1682 allows the user to control how and in what manner others are allowed to access portions of their profile. The privacy settings region 1682 include a first user interface control 1684 that can be selected by a user to permit other users to follow the user. In such case, other users will be able to access the user's personal information previously provided in the user profile, such as name, picture, “Where I Live,” and “About Me” information. A second user interface control 1686 can be selected by the user to required user approval for any “follow” requests. Here, if this option is selected, the social networking system will prompt the user to approve any other users before such other users can follow the user's activity (e.g., activity feed). Still further, the profile creation screen 1680 can include a third user interface control 1688 which, upon selection, renders the user's profile hidden. When the user's profile is to be hidden, the personal information provided within the user profile is not available to other users (i.e., not publicly available).

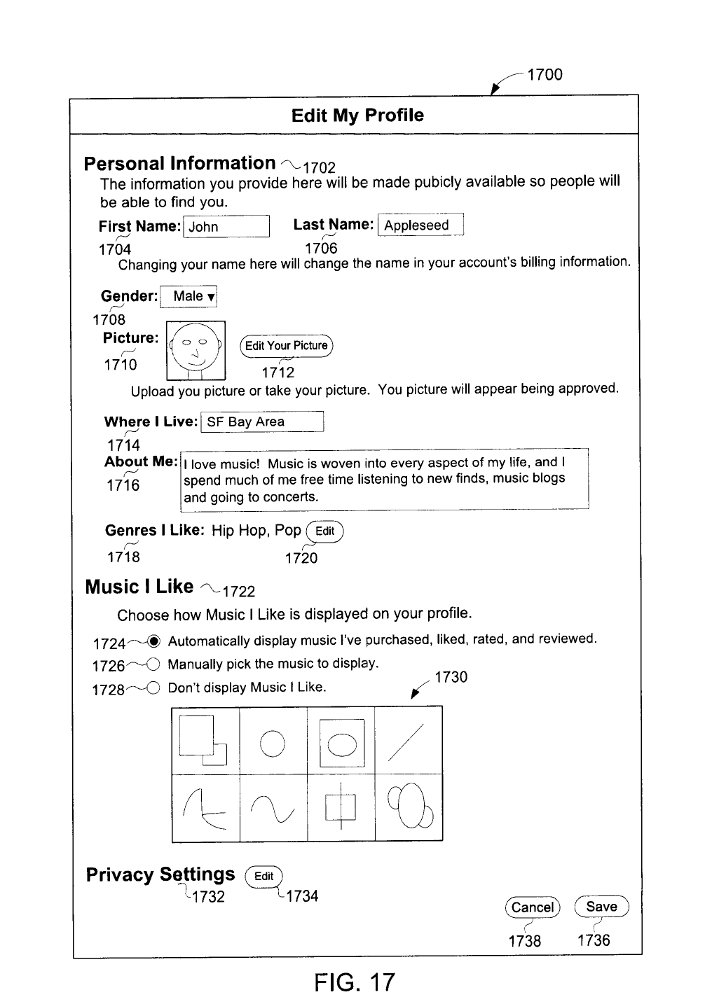

FIG. 17 is a view of a representative profile edit screen 1700 according to one embodiment. The profile edit screen 1700 can represent one embodiment of the general profile page 1500 illustrated in FIG. 15. The profile edit screen 1700 is also similar to the profile creation screen 1600 illustrated in FIG. 16A. In one embodiment, the profile edit screen 1700 can be used to edit (or alter) the user profile that was previously created using the profile creation screen 1600.

The profile edit screen 1700 includes a personal information region 1702. A user can interact with the profile edit screen 1700 to edit previously provided personal information about the user that can be made publicly available on a social networking system. In the example illustrated in FIG. 17, the personal information region 1702 can allow a user to edit a first name 1704, a last name 1706, and a gender 1708. The personal information region 1702 can also allow the user to edit a picture 1710 pertaining to the user. A user interface control 1712 can assist the user in uploading an image for use as the picture 1710 associated with the profile for the user. In one implementation, the social networking system can require approval of the uploaded image prior to being made available as one's picture on the social networking system.

In addition, the personal information region 1702 can also include residential information 1714 (e.g., denoted “Where I Live”) for the user, such as city and state, which can be edited. Still further, the personal information region 1702 can include a narrative section 1716 (e.g., denoted “About Me”), which was previously provided by the user as a short description about themselves, and which can be now edited.

Furthermore, the profile edit screen 1700 can also include a genre selection section 1718 that specifies the genres of media (e.g., music) associated with the user profile. The profile creation screen 1700 can have an edit user interface control 1720 that facilitates a user in altering the previously established genre selections. For example, upon selection of the edit user interface control 1720, the profile edit screen 1700 can be altered to additionally display a genre selection section, such as the genre selection section 1618 illustrated in FIG. 16A that assists the user in re-specifying genres of media (e.g., music) that they would associate with their user profile.

The profile edit screen 1700 can also include a media interests region 1722 that is denoted “Music I like”. In the media interests region 1722, the user is able to revisit previously associated media items, such as musical items, with their profile. Additionally, the selection of the musical items can be automatic or manual. A first user control 1724 can be selected by the user to cause the musical items to be automatically selected. The automatic selection can be performed, for example, based on music that user has purchased, “liked”, rated or reviewed. A second user control 1726 can be selected by the user to facilitate manual selection of the musical items. In such case, although not shown in FIG. 17, an additional user interface control can be further added to the profile edit screen 1700 to assist the user in identifying musical items. For example, the additional user interface control can be a search or browse functional control. A third user interface control 1728 can be selected by the user to indicate that the user does not want the media interests region 1722 of their profile to designate any particular media items that might represent them.

The profile edit screen 1700 can also include a media profile depiction 1730. The media profile depiction 1730 can provide a representation of a predetermined number of media items, namely, musical items, that have been previously selected to be included within the media profile. The media profile depiction 1730 can not only facilitate selection of the media items for the media profile but also can present the media profile being created to the user so that the user understands how the media profile will appear to others accessing their profile using the social networking system.

In the example illustrated in FIG. 17, the profile edit screen 1700 indicates that the user has selected the first user control 1724 to request that the music profile be generated automatically. Consequently, the media profile depiction 1730 has been automatically updated to include the predetermined number of media items within the media profile. In this example, each of the media items being assigned to the media profile is depicted as an image, namely, an album cover art associated with the media item (e.g., song). However, the user is able to alter the media profile by re-arranging the selections, deleting one or more selections, switching to manual selection, or disabling the media profile.

The profile edit screen 1700 can also include a privacy settings region 1732 that is designated “privacy settings”. The privacy settings region 1732 allows the user to control how and in what manner others are allowed to access portions of their profile. The privacy settings region 1732 can have an edit user interface control 1734 that facilitates a user in altering the previously established privacy settings. For example, upon selection of the edit user interface control 1734, the profile edit screen 1700 can be altered to additionally display a privacy setting region, such as the privacy setting section 1682 illustrated in FIG. 16E, to assist the user in alter previously established privacy settings for the user profile.

The profile edit screen 1700 can include a save button 1736 to save any changes that have been made to the profile. A cancel button 1738 can be used to abort any changes made to the profile edit screen 1700.

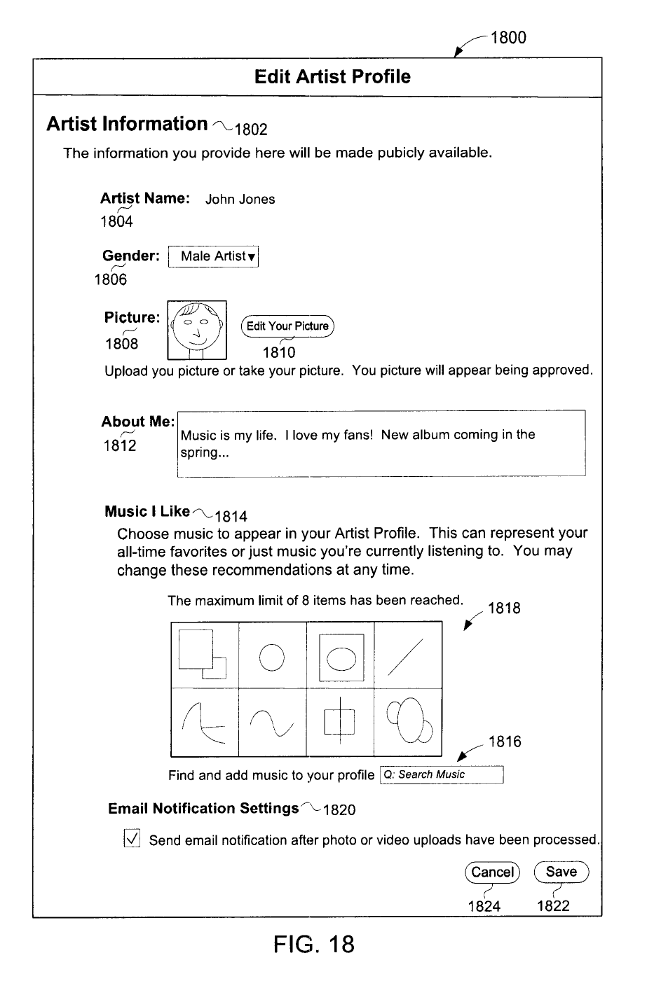

While the profile edit screen 1700 can be used by any user to edit their profile, in one embodiment, certain users, such as artists, can be provided with profiles that are slightly different content. FIG. 18 is a view of a representative artist profile edit screen 1800 according to one embodiment. The artist profile edit screen 1800 is similar to the profile edit screen 1700 illustrated in FIG. 17 except that it is designed for artists to edit an artist's profile. In one embodiment, the artist profile edit screen 1800 can be used to edit (or alter) the artist profile that was previously created for the artist using an artist profile creation screen, which could be similar to a profile creation screen (see FIGS. 16A-16D).

The artist profile edit screen 1800 includes an artist information region 1802. A user can interact with the artist profile edit screen 1800 to edit previously provided artist information about the user that can be made publicly available on a social networking system. In the example illustrated in FIG. 18, the artist information region 1802 can display the artist name 1804, and can allow an artist to edit a gender 1806. The artist information region 1802 can also allow the artist to edit a picture 1808 pertaining to the artist. A user interface control 1810 can assist the artist in uploading an image for use as the picture 1808 associated with the profile for the artist. In one implementation, the social networking system can require approval of the uploaded image prior to being made available as one's picture on the social networking system. In addition, the artist information region 1802 can also include a narrative section 1812 (e.g., denoted “About Me”), which was previously provided by the artist as a short description about themselves, and which can be now edited.

The artist profile edit screen 1800 can also include a media interests region 1814 that is denoted “Music I like”. In the media interests region 1814, the user is able to revisit previously associated media items, such as musical items, with their profile. While the selection of the musical items can be automatic or manual, in this embodiment, the artist manually identifies musical items to be included in the profile. A user interface control 1816 can be provided with the artist profile edit screen 1800 to assist the user in identifying musical items. For example, the additional user interface control 1816 can be a search or browse functional control.

The artist profile edit screen 1800 can also include a media profile depiction 1818. The media profile depiction 1818 can provide a representation of a predetermined number of media items, namely, musical items, that have been previously selected to be included within the artist's media profile. The media profile depiction 1818 can not only facilitate selection of the media items for the media profile but also can present the media profile being created to the user so that the user understands how the media profile will appear to others accessing their profile using the social networking system. The artist is able to alter the media profile by re-arranging the selections, deleting one or more selections, or adding other selections.

The artist profile edit screen 1800 can also include an email notification settings region 1820 that is designated “Email Notification Settings”. The email notification settings region 1820 allow the user to control whether an email notification is to be sent after media (e.g., photos or video) have been processed.

The artist edit screen 1800 can include a save button 1822 to save any changes that have been made to the profile. A cancel button 1824 can be used to abort any changes made to the artist profile edit screen 1800.

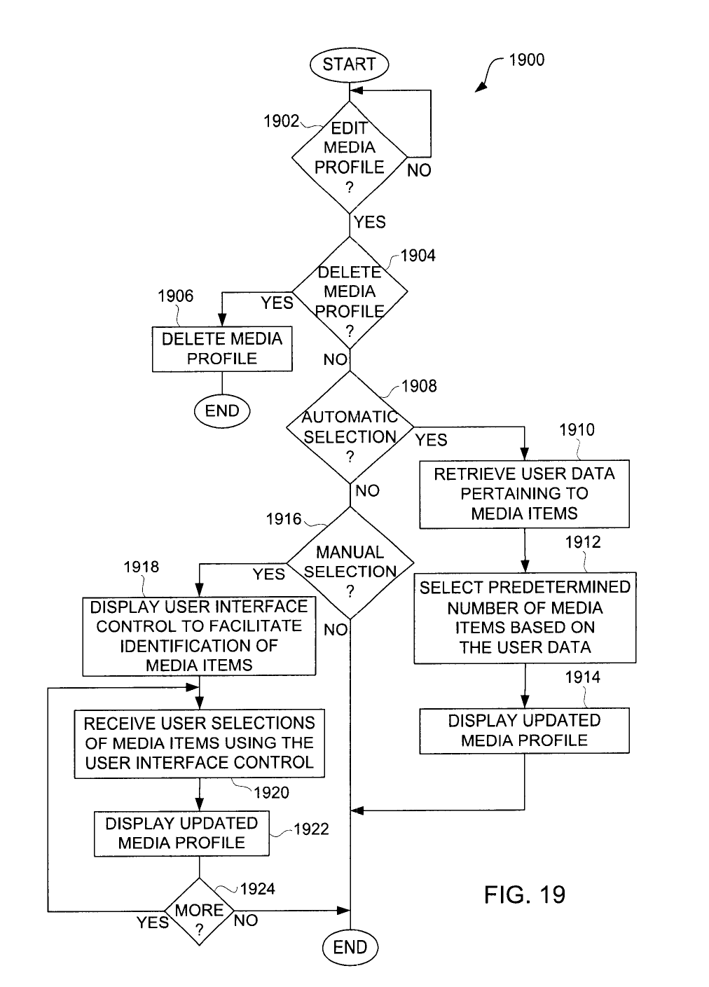

FIG. 19 is a flow diagram of a media profile setting process 1900 according to one embodiment. The media profile setting process 1900 can be performed by a server, client computer, or other computing device.

The media profile setting process 1900 can begin with a decision 1902 that determines whether a media profile associated with a user is to be edited (or altered). When the decision 1902 determines that a media profile is not to be edited at this time, the media profile file setting process 1900 awaits the need to edit a media profile. Once the decision 1902 determines that a media profile is to be edited, the media profile setting process 1900 can continue. In other words, the media profile setting process 1900 can be effectively invoked when a media profile is to be edited.

Once the decision 1902 determines that a media profile is to be edited, a decision 1904 determines whether the media profile is to be deleted. For example, a user can delete a previously created media profile in the event that they no longer desire to have a media profile. When the decision 1904 determines that the media profile of the user is to be deleted, the media profile is deleted 1906 and the media profile setting process 1900 can end. Once the media profile has been deleted, a user can subsequently create a new media profile if so desired.

On the other hand, when the decision 1904 determines that the media profile is not to be deleted, a decision 1908 determines whether automatic selection is to be utilized in determining the media profile. When the decision 1908 determines that automatic selection is to be utilized, user data pertaining to media items can be retrieved 1910. The user data is, for example, user purchase history data, user media data, user review data, or any other information associated with the user that is maintained by the social networking system. After the user data pertaining to the user has been retrieved 1910, a predetermined number of media items can be selected 1912 based on the user data. The predetermined number of media items being selected 1912 can be used to form the media profile. Following the selection 1912 of the predetermined number of media items, the updated media profile can be displayed in 1914. In this case, the media profile associated with the user has been altered such that the media items for the media profile are automatically selected.

Alternatively, when the decision 1908 determines that automatic selection is not to be utilized in determining the media profile, a decision 1916 can determine whether manual selection is utilized to determine the media profile. When the decision 1916 determines that manual selection is to be utilized, a user interface control can be displayed 1918 to facilitate identification of media items to be included, manually, in the media profile. Next, one or more user selections of media items can be received 1920 using the user interface control. Typically, in the user selections of the media items are such that a predetermined number of media items are selected. After the user selections of the media items have been received 1920, the media profile has been formed or altered. The updated media profile can then be displayed 1922. In this case, the media profile associated with the user has been altered such that the media items for the media profile are manually selected.

Following the display 1922 of the updated media profile, a decision 1924 can determine whether any more user selections are to be received. When the decision 1924 determines that more selections are to be received, the media profile setting process 1900 can return to repeat the block 1920 and subsequent blocks so that additional user selections can be received and processed. Alternatively, when the decision 1924 determines that there are no more user selections to be provided, the media profile setting process 1900 can end. Additionally, following the decision 1916 when manual selection is not to be performed, the media profile setting process 1900 can also end.

According to one aspect, a media profile can be used to identify different users that have similar media taste. For example, if the media profile contains up to ten (10) media items, different users that have a high correlation amongst the media items in the media profiles can cause the users to be denoted as more likely of interest to one another. As result, if recommendations on people to follow are being provided by the social networking system, the degree of correlation between their respective media profiles can be utilized as at least one factor in deciding such recommendations.

According to another aspect, media profiles for users can be static. For example, as discussed above, a user can manually set their media profile. Such media profile would be static, although the user can manually update their media profile whenever desired.

According to another aspect, media profiles for the users can be automatic. For example, as discussed above, a user can allow automatic creation of their media profile. In one implementation, the automatic creation of the media profile can be dynamically triggered periodically (e.g., daily) for based on user activity or events, so that the media profile can be automatically re-created. For example, the automatic creation of the media profile can be based on purchase history, “likes”, ratings or reviews. For instance, if the user purchases a new song from an online media store after their media profile was automatically created, the media profile may be re-determined because doing so would yield a different media profile that is likely more consistent with the current media interests of the user. However, the user might, in one embodiments, prefer that the media profile automatically created is not dynamically altered, at least not without their approval.

According to another aspect, a media profile can be dynamic such that a user is media profile can appear differently when presented to different users. The media profile can be presented to a user in variety of different ways, such as part of a user page, a connection page, or some other electronic page. Also, as noted above, the media profile can include images representing me media items within the media profile. Consider an example where a first user is seeking to view a second user's media profile. The dynamic aspect for the media profile can, for example, be implemented by comparing a base media profile for a first user to a base media profile for the second user. Here, the media profile can be dynamically set for use by at least the second user based on the comparison between the base media profiles. For example, if the first user's media profile has media items pertaining to rock as well as classical music, the dynamic media profile seen by the second users might emphasize the first user's interest in classical music if the media profile for the second user indicates an interest in classical music (and not rock music). In one implementation, the comparison (or correlation) between the media profiles can be presented numerically or visually. For example, the media items “we both liked” can be designated and displayed. In an additional embodiment, there can be processing to correlate media libraries associated with different users in a same or similar manner as can be utilized to correlate media profiles. Such information could provide a more in depth data set to present information regarding similarities, correlations or other relationships that can be supported by similarities or differences in their respective media libraries. Such information could be utilized to recommend media items, for purchase or otherwise, to users.

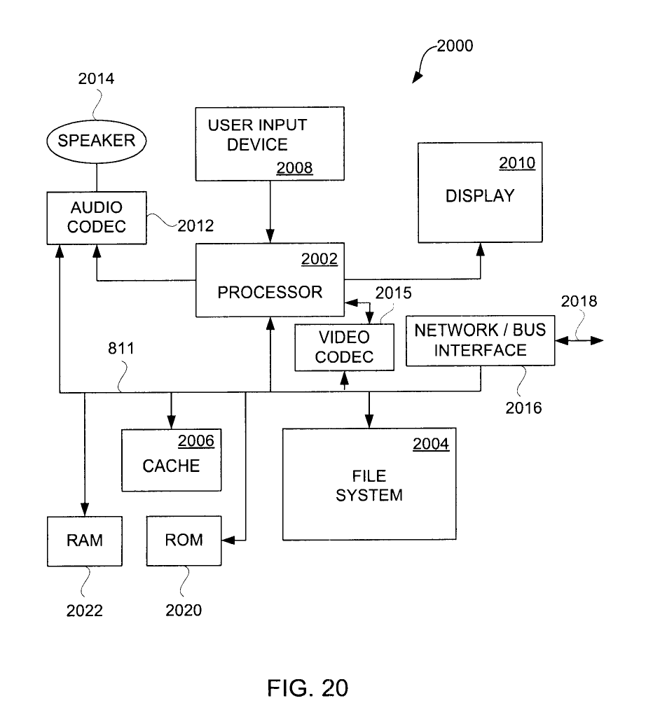

FIG. 20 illustrates a block diagram of a computing device 2000 according to one embodiment. The computing device 2000 can represent circuitry of a representative computing device (e.g., user or follower computer device), central server, or online store (e.g., online media server) described and illustrated in FIG. 1. The computing device can be designed to primarily stationary or can be portable.

The computing device 2000 includes a processor 2002 that pertains to a microprocessor or controller for controlling the overall operation of the computing device 2000. The computing device 2000 stores media data pertaining to media items in a file system 2004 and a cache 2006. The file system 2004 is, typically, semiconductor memory (e.g., Flash memory) and/or one or more storage disks. The file system 2004 typically provides high capacity storage capability for the computing device 2000. However, since the access time to the file system 2004 can be relatively slow, the computing device 2000 can also include the cache 2006. The cache 2006 is, for example, Random-Access Memory (RAM). The relative access time to the cache 2006 is typically shorter than for the file system 2004. However, the cache 2006 does not have the large storage capacity of the file system 2004. The computing device 2000 also includes a RAM 2020 and a Read-Only Memory (ROM) 2022. The ROM 2022 can store programs, utilities or processes to be executed in a non-volatile manner. The RAM 2020 provides volatile data storage, such as for the cache 2006.

The computing device 2000 may also include a user input device 2008 that allows a user of the computing device 2000 to interact with the computing device 2000. For example, the user input device 2008 can take a variety of forms, such as a button, keypad, dial, touch-sensitive surface, etc. Still further, the computing device 2000 includes a display 2010 (screen display) that can be controlled by the processor 2002 to display information to the user. A data bus 2011 can facilitate data transfer between at least the file system 2004, the cache 2006, the processor 2002, an audio coder/decoder (CODEC) 2012 and/or a video CODEC 2015.

In one embodiment, for example, if the computing device 2000 is a media player, the computing device 2000 may store a plurality of media items (e.g., songs, videos, podcasts, etc.) in the file system 2004. When a user desires to have the computing device play a particular media item, a list of available media items is displayed on the display 2010. Then, using the user input device 2008, a user can select one of the available media items. The processor 2002, upon receiving a selection of a particular media item, supplies the media data to one or more appropriate output devices. If the particular media item is encrypted, the particular media item is first decrypted as noted above, which could involve one or more layers of encryption. As an example, for audio output, the processor 2002 can supply the media data (e.g., audio file) for the particular media item to the audio CODEC 2012. The audio CODEC 2012 can then produce analog output signals for a speaker 2014. The speaker 2014 can be a speaker internal to the computing device 2000 or external to the computing device 2000. For example, headphones or earphones that connect to the computing device 2000 would be considered an external speaker. As another example, for video output, the processor 2002 can supply the media data (e.g., video file) for the particular media item to the video CODEC 2015. The video CODEC 2015 can then produce output signals for the display 2010 and/or the speaker 2014.

The computing device 2000 also includes a network/bus interface 2016 that couples to a data link 2018. The data link 2018 allows the computing device 2000 to couple to another device (e.g., a host computer, a power source, or an accessory device). The data link 2018 can be provided over a wired connection or a wireless connection. In the case of a wireless connection, the network/bus interface 2016 can include a wireless transceiver.

Additional information is provided in U.S. Provisional Patent Application No. 61/378,817, filed Aug. 31, 2010, entitled “CLASSIFICATION AND STATUS OF USERS OF NETWORKING AND SOCIAL ACTIVITY SYSTEMS,” and incorporated herein by reference for all purposes.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for providing a recommendation to a user of a social networking system, the method comprising:
receiving one or more events concerning activity at the social networking system;
determining whether to trigger a recommendation based on the one or more of the received events;
identifying one or more users of the social networking system that are potentially interested candidates;
preparing at least one content recommendation; and
rendering the at least one content recommendation available for presentation to one or more of the respective users.

2. A method as recited in claim 1, wherein the identifying identifies the interested candidates based on user attribute information respectively corresponding to the one or more users of the social networking system.

3. A method as recited in claim 2, wherein the user attribute information includes at least user usage information or user collection information.

4. A method as recited in claim 2,
wherein the one or more events have event information associated therewith, and
wherein the identifying comprises comparing the event information pertaining to the one or more events to the user attribute information respectively corresponding to the one or more users of the social networking system.

5. A method as recited in claim 1, wherein the social networking system is associated with an online commerce site.

6. A method as recited in claim 5, wherein the online commerce site is an online media store.

7. A method as recited in claim 5, wherein the at least one content recommendation pertains to a product or service available for purchase at the online commerce site.

8. A method as recited in claim 5, wherein the at least one content recommendation pertains to a digital media asset available for purchase at the online commerce site.

9. A non-transitory computer readable medium including at least computer program code stored for providing a recommendation to a user of a networked system, the computer readable medium comprising:
computer program code for receiving one or more events concerning activity at the social networking system;
computer program code for determining whether to trigger a recommendation based on the one or more of the received events;
computer program code for identifying one or more users of the social networking system that are potentially interested candidates;
computer program code for preparing at least one content recommendation; and
computer program code for rendering the at least one content recommendation available for presentation to one or more of the respective users.

10. A method for forming a profile for a user of a social networking system, the method comprising:
maintaining user data for each of a plurality of users of the social networking system;
identifying a particular user for which a media profile is to be created or edited;
accessing user data for the particular user that is maintained by the social networking system;
automatically selecting at least one media item for inclusion into the media profile based on the user data, the at least one media item being selected from a plurality of media items; and
including the selected at least one media item in the media profile.

11. A method as recited in claim 10, wherein the media profile comprises a plurality of different media items, and
wherein the automatically selecting comprises automatically selecting at least a plurality of the different media items to be included in the media profile based on the user data.

12. A method as recited in claim 10, wherein the user data includes at least purchase history data indicating media items that have been previously purchased by the user.

13. A method as recited in claim 10, wherein the user data includes at least data identifying media items that have been rated or reviewed by the user.

14. A method as recited in claim 10, wherein the user data includes at least data identifying media items that have been “liked” by the user.

15. A method as recited in claim 10, wherein the method comprises:
subsequently displaying the media profile, and
wherein the media profile being displayed is presented on a display screen associated with a computing device.

16. A method as recited in claim 10, wherein the media profile is displayed such that a plurality of images respectively representing each of a plurality of the media items included in the media profile.

17. A method as recited in claim 16, wherein the displayed images are display in a table format.

18. A computer readable medium including at least computer program code for forming a profile for a user of an online media system, the method comprising:
computer program code for maintaining user data for each of a plurality of users of the social networking system;
computer program code for identifying a particular user for which a media profile is to be created or edited;
computer program code for accessing user data for the particular user that is maintained by the social networking system;
computer program code for automatically selecting at least one media item for inclusion into the media profile based on the user data, the at least one media item being selected from a plurality of media items; and
computer program code for including the selected at least one media item in the media profile.

19. A computer readable medium as recited in claim 18, wherein the online media system includes or is coupled to a social networking system.

20. A graphical user interface for providing a user profile, comprising:
a personal information region configured to facilitate user entry of information pertaining to a user; and
a media interests region configured to facilitate identification media items of interest to the user.

21. A graphical user interface as recited in claim 20, wherein the identified media items of interest to the user form a media profile.

22. A graphical user interface as recited in claim 20, wherein the media items of interest to the user are selected manually selected by the user.

23. A graphical user interface as recited in claim 20, wherein the media items of interest to the user are automatically selected by a computing device.

24. A graphical user interface as recited in claim 20, wherein the personal information region includes at least a user description element that facilitates user entry of a description about the user.

25. A graphical user interface as recited in claim 20, wherein the user is an artist.

26. A graphical user interface as recited in claim 20, wherein the media interests region includes at least one user interface control to select whether manual or automatic identification is to be used for the media items of interest to the user.

27. A graphical user interface as recited in claim 20, wherein the media interests region includes at least a media profile depiction.

28. A graphical user interface as recited in claim 27, wherein the media profile depiction presents a plurality of images that respectively represent the identified media items of interest.

29. A graphical user interface as recited in claim 28, wherein the media profile depiction presents the plurality of images in a grid format.

30. A graphical user interface as recited in claim 20, wherein the graphical user interface further comprises:
a privacy settings region configured to facilitate user selection of at least one privacy setting.
